(19) United States
(12) Patent Application Publication
(10) Pub. No.: US 2003/0069787 A1
(43) Pub. Date: Apr. 10, 2003

(54) Computer system and method for the establishment of a virtual marketplace of promotional values

(75) Inventors: Steve Tendon, Tigerstigen (SE); Andreas Wallen, Goteborg (SE)

Correspondence Address: LERNER, DAVID, LITTENBERG, KRUMHOLZ & MENTLIK, LLP, 600 South Avenue West, Westfield, NJ, 07090, US

(73) Assignee: TENDON CONSULTING GROUP KB

(21) Appl. No.: 09/862,356

(22) Filed: May 22, 2001

(51) Int. Cl. G06F 17/60

(52) U.S. Cl. 705/14

(57) ABSTRACT

The invention relates to a distributed computer system for the establishment of a marketplace for branded promotional values issued by at least two businesses and being awarded to at least two consumers. The invention also relates to a method for the establishment of a marketplace of branded promotional values issued by at least two businesses and being awarded to at least two consumers. Also, the invention relates to a method for facilitating and improving marketing and promotional activities through the establishment of a marketplace for branded promotional values issued by at least two businesses and being awarded to at least two consumers. By means of the invention, businesses are allow to interact with mobile consumers via wireless interactive marketing services. In this manner, consumers are allowed to earn, spend and trade so-called M-points, which are associated with a corresponding issuing business, and attributed by a point value determined by the corresponding issuing business. The invention allows for the interchangeability of points issued by different merchants, which in turn allows automatic co-/cross-marketing between different businesses.

### TECHNICAL FIELD

The invention relates to a transactional engine supporting interactive promotional systems, and methods and terms of service for point based promotional systems.

In particular, the invention relates to a distributed computer system for the establishment of a marketplace for branded promotional values issued by at least two businesses and being awarded to at least two consumers.

Furthermore, the invention relates to a method for the establishment of a marketplace of branded promotional values issued by at least two businesses and being awarded to at least two consumers.

Also, the invention relates to a method for facilitating and improving marketing and promotional activities through the establishment of a marketplace of branded promotional values issued by at least two businesses and being awarded to at least two consumers.

### BACKGROUND OF THE INVENTION

Promotional Programs

Many types of companies, for example department stores, grocery shops and financial institutions such as banks and credit card companies, offer various promotional programs for promoting the sale of products or services to their customers. With the emergence of the Internet, there is an ongoing effort to execute such promotional programs online. With the advent of wireless Internet-enabled mobile devices (such as cellular phones, PDAs, portable computers, and even with telematics equipped automobiles and other so-called “smart vehicles,” etc.) there is a latent need to extend the promotional programs to such new media. Furthermore, there is a need to coordinate online and offline promotional efforts.

Traditionally, companies launch campaigns involving discounts or refunds for their customers. In this manner, it is expected that sales will increase. For example, companies often distribute discount coupons by postal mail to the general public. A person having such coupons may then benefit from a refund of the price of a particular product or service, or a free sample. Online variations of such a concept offer electronic coupons (e-coupons) via email, whereby the e-coupon can be redeemed by an online or offline merchant.

A particular type of loyalty promotional program is used, for instance, by airline companies, in which a customer may receive a “frequent flyer” bonus, normally in the form of a number of bonus points corresponding to the value of a purchased flight ticket. When the customer has collected a certain amount of bonus points, these points can be used for purchasing another flight ticket from the airline company in question.

Prior Art

The patent document U.S. Pat. No. 5,983,196 discloses a computer based system in which a customer may receive award credits by connecting via for example a telephone or the Internet. Such award credits can be gained if the customer registers information related to coupons which are provided on various goods purchased by the customer. In this system, award credits can also be acquired as an instant winner based on a random or algorithmic selection of callers. Awards include electronic prizes such as free long distance telephone time, electronic cash and/or service credits. Connection to the interactive platform may occur during execution of an application program such as an electronic game or electronic shopping.

The patent document U.S. Pat. No. 5,774,870 discloses a fully integrated on-line frequency award program, whereby a user may browse an on-line product catalog for shopping and place on-line orders. The program automatically issues purchase orders to the supplying company. The program also calculates award points, updates the award account of enrolled users, and communicates that number of awarded points to the user. Enrolled users may browse through an award catalog and electronically redeem an amount of awarded points towards an award. The program then electronically places an award redeeming order with the fulfillment house and updates the user's award account.

Business Needs with Wireless Internet

Existing promotional programs operate by taking advantage of various media, like traditional mail, telephone and the Internet. A business conducting conventional or on-line (i.e. Internet based) marketing activities needs to find a way to accomplish similar or new marketing activities over the wireless medium. It needs to reach the growing market of consumer having a personal, mobile and wireless Internet-enabled device. Traditionally these businesses have relied upon advertising agencies and direct marketing companies to resolve their marketing communication needs. Such intermediaries need to be able to provide their services over the new wireless medium.

With the massive market of mobile consumers emerging during the next few years, it is vital to determine how businesses can interact with their mobile customers. Due to the intrinsic limitations of wireless devices (bandwidth, form-factor, ergonomics, screen size, etc.), it cannot be expected that users operate as if they were using the “traditional” wire-line Internet. In other words, navigating and browsing are simply not feasible. What needs to happen is that light-weight, easy-to-use, value-added services need to be delivered via the wireless medium.

In the following, the demands and requirements for providing marketing and promotional programs of various types will be discussed. Also, various problems associated with previously known marketing and promotional methods and systems will be discussed in detail.

Co-Marketing and co-/Cross-Marketing

Companies investing marketing money are constantly seeking new marketing channels, and while the benefits of co-marketing and/or co-/cross-marketing with other companies are well known, co-/cross-marketing is seldom achieved in practice. It would be desirable for companies to co-market and cross-market more effectively and frequently. In this regard, the term co-marketing is used in order to describe the situation in which two different businesses market together in a manner so that one business is able to take advantage of the marketing efforts of the other business, and vice versa. Furthermore, the term co-/cross-marketing is used in order to describe a situation in which one business can take advantage of different campaigns or promotions to market different products. For example, a retailer could promote a particular product A, but then generate a sale for another product B, via that promotion.

Marketing Communication Needs

In the area of interactive marketing, advertising agencies and direct marketing companies need to be able to offer to their current customers a way to achieve effective marketing via the mobile devices. They face a huge problem: that of delivering marketing communication and implementing promotional activities over the wireless medium.

The problem is evident both in terms of technology infrastructure, as well as in terms of business models and business methods. The majority of advertising agencies and direct marketing companies do not have the technology infrastructure or know-how to effectively approach the wireless internet and be able to provide interactive marketing services to their current customers. Furthermore, notwithstanding the technical problem, they still need to figure out what marketing methods can be used effectively over the wireless medium. Specifically, advertising agencies and direct marketing companies need a wireless interactive marketing infrastructure and method that allows them to solve the following problems:

1) exploit the wireless Internet as a new media channel, as all traditional channels have nearly reached the point of saturation;

2) be able to offer to their business customers a diversity of consumer oriented incentive and promotional programs that exploit personal wireless internet-enabled mobile devices;

3) realize and manage such wireless, online interactive marketing activities;

4) supervise consumers' award redemption and/or fulfillment;

5) effectively implement one-to-one marketing operations and surgically targeted promotions; and

6) ensure consumer privacy as required by government laws.

Furthermore, traditional advertising agencies and direct marketing companies need to compete with new-economy marketing companies. The majority of advertising agencies have been caught off-guard with the advent of the Internet. Presently, many of them have just managed (or are in the process) to catch up with the Internet. Most of them are now able to offer web page development services, often in co-operation with or by outsourcing the assignment to web-shops. However, most advertising agencies have missed the opportunity of providing solutions to their customers in terms of interactive marketing over the Internet. For this specific purpose, a number of startups have been established during the last couple of years. This new kind of marketing company constitutes a serious threat for traditional marketing companies, especially as more and more business tends to become e-business. Even more so when the enormous volume of mobile consumers need to be addressed as a marketing target.

Pitfalls of CRM and “One-to-one” Marketing Practices

Current interactive marketing systems and methods imply the use of databased-marketing techniques in order to track information about customers and prospects. Typically, data is gathered both by asking consumers directly to provide personal information, and by monitoring consumers' behavior, usage and purchase patterns. During recent years, so called “customer relationship management” (CRM) systems and “one-to-one marketing” practices have been developed to take advantage of marketing databases (often in the form of data-warehouses with data-mining techniques), and gather even more information about consumers. Naturally, the purpose of such activities is to match offerings with customer needs in a more precise way, and to identify buying patterns in order to achieve proactive marketing. However, such techniques have severe constraints and problems.

Some constraints are of technical nature, and pertain to the mere volume, and nature of the collected data. For instance, published references indicate that currently Microsoft collects 70.000 billions of bytes of consumer data per year, and only for its web-site related activities. It is evident that such intensive data-collection activities by an advertising agency on behalf of its several customers acting in the mobile consumer market (which will be several orders of magnitude greater than the current wire-line Internet market) are simply impractical. Another difficulty of CRM and one-to-one marketing is that they are almost impossible to realize for companies selling consumer-products, where the final consumer is totally anonymous. A typical example is the food industry. In these cases, the four fundamental principles of one-to-one marketing (Identify, Differentiate, Interact and Customize) cannot be applied simply because step one is materially impossible.

Yet another weakness of CRM and databased-marketing techniques is that they are fundamentally based on past information. Customer profiles and purchase histories are not always a good guide, and especially they are not a trustworthy predictive indicator of what customers intend to do in the near future. It is difficult to conduct proactive marketing. It is like the classical saying, about driving a car by looking in the rear-mirror.

Need to Comply with Privacy Laws

The major constraint on CRM and “One-to-one” Marketing practices is of juridical nature. These techniques depend on the ability to develop and maintain individual consumer profiles and historic records. It is not uncommon to combine personal information with web site navigational data, transactional information, demographic and psychographics data. This is in striking conflict with the need to comply with privacy laws issued in many countries, and specifically in EU countries. As regards Europe, the EC Directive 94/EC and Directive 95/EC of the European Parliament and of the Council on the Protection of Individuals With Regard to the Processing of Personal Data And on the Free Movement of Such Data is particularly referred to.

In particular, these business models face the risk that regulations are enacted that restrict marketer's ability to collect or use information about consumers. An attempt to overcome these restrictions is the adoption of “permission marketing” practices, by explicitly asking consumers to provide information about themselves, and to acknowledge what kind of promotional messages they accept to receive. However, security and privacy concerns may cause consumers to resist providing the personal data necessary to support this profiling capability with proficiency. This creates a problem in terms of data completeness and accuracy.

Marketing companies may incur significant costs to protect against the threat of security breaches. If security and privacy were compromised and, somehow, well-publicized, then marketing companies could face a severe decline in their business.

Another threat in the on-line world is the potential exposure to hostile attacks, whereby third parties could steal, alter or publicize information in the marketing database, with the purpose of damaging the business. Public perceptions of such problems, and especially perception that consumer information be released (or even worse, used) without authorization, could have catastrophic consequences.

Need for Non-Obtrusive Marketing Communication

E-mail abuse, “spamming,” misinterpretation, and so on are already annoying phenomena in the Internet scenario. Consumers strongly reject them. Ordinary postal junk mail is hard to bear. The bombardment of television ads is overwhelming. Anything equivalent on a personal mobile device would be intolerable. Push-models for advertising are doomed to fail. Marketers need to find a way to be deliver promotional messages in a non-obtrusive way.

Needs and Desires of Mobile Consumers

It can be assumed that transactional services will be the most widely used services on wireless Internet-enabled mobile devices. Consumers favor services that can deliver real value to them. Entertainment and information services, whilst important, are perceived as less essential. Consumers will be more intimately involved with their mobile devices if these bear real value.

As mentioned above, advertising agencies and direct marketing companies need to comply with privacy laws. This need has a natural complement in the consumers' perception too. In today's computerized society, “Big Brother Paranoia” is not a totally misplaced concern. Consumer movements are increasingly aware of privacy problems, and media is covering the subject more and more frequently. Cases of personal information abuse are setting precedents. The consumer claims rights to his own privacy.

Limitations of Prior Promotional Systems

Point based programs are typically issued by one single merchant. Typically, a consumer can redeem points collected from one merchant only for products or services from that very same merchant. Points belong forever to the individual consumer that earned them. Terms of service typically forbid consumers to trade, barter, auction or transfer ownership of points. One problem with this approach is that the promotional value represented by points might not reach a consumer willing to take advantage of it, because it remains stranded with a consumer who will not spend it.

Traditionally, points according to known systems have an expiration date, and cannot be redeemed or used in any way thereafter. The rational is that points with an expiration date have a greater chance of being redeemed. However, this introduces the problem of how to value all expired and unredeemed points, since they are a negative marketing investment.

Current on-line interactive marketing promotional system based on points, have un-branded points. Recent online marketing companies have attempted to achieve the interchangeability of promotional values between different merchants by coining “virtual” currencies. Their points act as virtual-currencies, whereby the marketing company acts as a service provider for businesses and manage all the underlying accounting. However, with such systems, in order to achieve the benefits of CRM/one-to-one marketing, the marketing companies need to gather or infer a profile of each consumer.

Traditional on-line promotional system handle advertising in one of two ways. Either they make on-line marketing communication impressions (i.e. online advertising) a point earning opportunity; in other words, consumers earn points by actively observing advertisements (also known as “pay-to-play” advertising). Alternatively, they use “opt-in” direct marketing (i.e. permission marketing), and thereby send promotional email messages to consumers who have given their explicit consent. In the long run, both methods are tiresome and bothering for the consumer.

Marketing companies relying on permission marketing need to have strong privacy policies. Such companies must simply promise to consumers that personal information will be kept confidential, and consumers have to take their word for it. Traditional point based system work well either for offline purchases, or for on-line purchases; but not for both. For instance, a paper coupon cannot be redeemed via a web browser. Vice-versa, an e-coupon cannot (easily) be redeemed at a shop's cash register.

Traditional point-based systems do not allow consumers to exchange points, nor do they brand points according to issuing businesses. Therefore, traditional point-based systems lack the means for measuring consumer's real interests.

Traditionally, the delivery vehicle of points to consumers have been paper based for offline promotions (like: cards, tags, stickers, labels, POS materials, product packaging, samples, premiums or any other vehicle or form). Sometimes, a magnetic card is used in order to facilitate the identification of consumers. On the other hand, on-line promotions typically identify consumers by username/password protected accounts. Points are credited to consumers' accounts when the consumers perform specific on-line activities (click-through, purchase, marketing exposure, etc.).

### SUMMARY OF THE INVENTION

A primary object of the invention is to provide methods, systems and software engineering designs for overcoming the problems of the prior art described above. In particular, the purpose of the invention is to provide an improved interactive promotional system, i.e. a system which takes into account actions done by the consumer. This object is accomplished by means of a computer system according to subsequent claim 1.

Accordingly, and according to a first aspect, the invention relates to a distributed computer system for the establishment of a marketplace for branded promotional values issued by at least two businesses and being awarded to at least two consumers, said distributed computer system comprising: a persistent storage node arranged for storing data related to said promotional values, said at least two businesses and said at least two consumers; an application server node for managing data stored by said persistent storage node, for executing transaction processing regarding said data, and for interfacing with said at least two businesses and said at least two consumers; said distributed computer system being adapted for communicating with said at least two businesses and for communicating with mobile communication devices associated with said at least two consumers; said distributed computer system being arranged to allow transactions involving said promotional values between said at least two businesses and said at least two consumers, thereby providing said marketplace between said at least two businesses, and between said at least two consumers, respectively.

The above-mentioned object is also accomplished by means of a method according to subsequent claim 16. Accordingly, and according to a second aspect, the invention relates to a method for the establishment of a marketplace of branded promotional values issued by at least two businesses and being awarded to at least two consumers, said method comprising: storing data related to said promotional values, said at least two businesses and said at least two consumers in a persistent storage node; managing said stored data and interfacing with said at least two businesses and said at least two consumers, by means of an application server node; transmitting information related to said promotional values, said at least two businesses and said at least two consumers by communicating with said at least two businesses and with mobile communication devices being associated with said at least two consumers; and allowing transactions involving said promotional values between said at least two businesses and said at least two consumers by means of said distributed computer system, thereby providing said marketplace between said at least two businesses, and between said at least two consumers, respectively.

The above-mentioned object is also accomplished by means of a method according to subsequent claim 29. Consequently, and according to a third aspect, the invention relates to a method for facilitating and improving marketing and promotional activities through the establishment of a marketplace of branded promotional values issued by at least two businesses and being awarded to at least two consumers, said method comprising: storing data related to said promotional values, said at least two businesses and said at least two consumers; managing stored data and transmitting data related to said promotional values to and from mobile communication devices being associated with said consumers; and allowing transactions involving said promotional values between said at least two businesses and said at least two consumers, thereby providing said marketplace between said at least two businesses, and between said at least two consumers, respectively.

Consequently, the invention relates to a computing infrastructure in terms of hardware and software that enables the establishment of a virtual marketplace for branded promotional values, such promotional values being issued by at least two businesses and awarded to at least two consumers.

Said computing infrastructure is typically a distributed, object-oriented computing system and comprises a number of nodes. In this context a “node” is some kind of computational unit, typically a computer. The nodes in the system comprise at least one persistent storage server, typically in the form of a database, capable of storing data related to said promotional value, said at least two businesses and said at least two consumers; at least one application server executing a set of processes managing the data stored by the persistent storage server and interfacing with said consumers' at least two mobile devices by means of at least one web server that manages http (hyper-text transfer protocol) communication towards at least one wireless gateway, that translates http communication to appropriate wireless protocol, like for instance WAP; said application server further interfaces with said business's web browsers on personal computers by means of said at least one web server. Preferably, said application server is responsible for managing and processing all transactions involving said promotional value between said at least two businesses and said at least two consumers. Furthermore said application server handles all detailed accounting functions, as to determine the degree of system utilization by said at least one business.

Furthermore, the invention relates to a method for the establishment of a virtual marketplace of branded promotional values. Said promotional values are issued by at least two distinct businesses and awarded, respectively, to at least two distinct individual consumers. According to an embodiment of the invention, said method comprises: transmitting information related to the issuance of promotional values between businesses and a central computing infrastructure; storing data related to promotional value, businesses and consumers in a persistent storage node of said computing infrastructure; transmitting information related to promotional values between computing infrastructure and the mobile internet-enabled communication devices owned by individual consumers; processing said data via application server nodes of said computing infrastructure; and allowing transactions involving transfer of ownership of promotional values: (1) from issuing business to consumer; (2) from consumer to another consumer; (3) from consumer back to issuing business. In particular, said transfer of ownership of promotional value between at least two distinct individual consumers enables the constitution of a virtual marketplace of promotional values between consumers. In particular, said computing infrastructure, allows single consumer to trade promotional values issued by one business for promotional values issued by another business. To this end, said computing infrastructure allows each business to autonomously determine a trade commission related to its own promotional values. Said trade commission is applied automatically and according to precise business rules and algorithms by said computing infrastructure in order to determine, indirectly, the equivalent amount of compensation that business on receiving end of trade will owe to business on issuing end of trade. This mechanism enables the constitution a virtual marketplace of promotional values between businesses.

The invention provides a possibility to create a marketing communication delivery vehicle over mobile media. Through the establishment of a virtual marketplace of branded promotional values issued by at least two businesses, and said branded promotional values being awarded to at least two consumers, said two businesses will be able to perform marketing communication directed to said consumers anytime said consumers gain ownership, via said virtual marketplace, of promotional values issued by said businesses. The act of gaining ownership of a promotional value is confirmed by means of an appropriate message sent to said consumer's mobile device. Such a message can be construed so that, in addition to the confirmation proper, it will also contain a marketing communication message issued by said same business issuing promotional values. Furthermore, since a consumer can act as to attract an increasing amount of promotional values of a certain business, and knowing what redemption levels have been set by said business, it become possible to measure, in terms of quantity and speed of promotional value ownership acquisition, how close the consumer is to said redemption level. Therefore it is possible to adapt the marketing communication message, and tailor it to the consumer's manifest interest. According to an embodiment, said method preferably comprises: accepting information related to the issuance of promotional value from at least one business via a communication network; accepting one or more marketing communication messages from business via communication network; accepting business rules from business pertaining to redemption levels of promotional values; accepting business rules from business pertaining to the presentation of marketing communication messages related to amounts or speed of acquisition of promotional values by said consumer; transmitting information related to said promotional value to and from a mobile communication device being associated with said user; combining such information with marketing communication established by said business and according to the said rules of combination with amounts or speed of acquisition of promotional values; storing data related to said amounts and/or speed of acquisition of promotional values and corresponding marketing communication messages determined by a business in a persistent storage medium.

The invention relates to interactive promotions, loyalty building and marketing communication. The invention meets a broad range of business objectives including: driving incremental sales, trial, loyalty, club membership, customer acquisition and individually or group targeted offerings.

According to an embodiment, the method according to the invention is built upon a loyalty-point mechanism with the following distinguishing features:

1) points are issued by different and distinct businesses, and therefore branded by the issuing business;

2) points are awarded to and are owned by consumers, and in particular point ownership is transferable from one consumer to another;

3) points of one brand are convertible into points of another brand (point morphing), according to predetermined rules and exchange rates;

4) once issued, points will never expire, unless explicitly redeemed by consumer;

5) a special kind of points, promotion points, may be issued by a business in relation to a specific promotional campaign; such promotion points have a limited time validity, but they will never expire;

6) at the end of the promotional period, promotion points will no longer be redeemable; however they do not exit the system but are transformed into collectible items, “golden points;” such golden points can potentially be reactivated (re-instantiated) by original issuing business at later stages for special promotional campaigns.

By means of the invention, a number of advantages will be obtained. The invention constitutes a basis for providing a technological infrastructure and a method that allows businesses to interact with the mobile consumer market via wireless interactive marketing services.

Consumers are allowed to earn, spend, trade, barter, auction, donate and collect points. If properly implemented, the invention can grant that consumers remain anonymous and connect to the services via the Internet, either through an ordinary web browser or, preferably, by using wireless, personal, Internet-enabled mobile devices.

The present invention is the basis for implementing a system and a method that can ensure that co-marketing is an ongoing, large-scale, and automatic activity.

The present invention delivers the same benefits of traditional CRM (Customer Relationship Management) and “Tone-to-one” marketing but without the necessity to handle massive amounts of data. In particular, the present invention allows consumer-product companies to achieve the benefits of CRM and one-to-one marketing, even with totally anonymous consumers.

Also, the present invention provides a method to measure consumers' purchase propensity based on current information, and not on extrapolations from past consumer behavior. The present invention can uncover consumers' intentions, and thereby enable predictive marketing communication and/or promotional activities to be undertaken.

As regards the requirements and need to comply with privacy laws, the invention provides a method and system by means of which it is possible to achieve the beneficial effects of CRM and one-to-one marketing, and ensuring the total privacy for consumers. In particular, the invention can be designed to comply with EU privacy law requirements and ensures privacy simply by avoiding to collect private information in the first place. The invention does not need such information in order to operate.

The present invention makes possible marketing communication in a non-obtrusive way, taking into account the psychology of marketing exposures. The present invention makes the marketing communication take place exclusively during activities initiated by the consumer himself, while the consumer is seeking a promotional value. The marketing communication message is presented concurrently with the delivery of real promotional value into the consumer wireless Internet-enabled mobile device, typically re-enforcing the promotional value itself (and vice-versa).

The present invention allows to implement a promotional system that delivers discount values directly into the consumer's wireless Internet-enabled mobile device, and thereby realize an attractive proposition for the mobile consumer. Also, by means of the invention consumers can be guaranteed that there will be no profiling nor tracking in terms of collecting navigational data, commercial transactional information, demographic data and psychographics data, simply because the system does not need the information thereof in order to function.

In contrast to the limitations of prior offline and online point based promotional system, the present invention allows merchants to issue their own branded points, and allows for the interchangeability of points issued by different merchants. This allows to automate co-/cross-marketing, and to establish cross-redemption commissions between different businesses automatically. Furthermore, consumers are not constrained to redeem their points for just one company's products or services.

It can be noted that the present invention establishes a virtual marketplace for branded promotional values and allows consumers to change point ownership by trade, barter, auction and transfer.

It can be claimed that through market dynamics, promotional values will reach those consumers that are most likely to take advantage of the promotion: for the obvious benefit of the issuing business. The system accelerates the delivery of promotional values and eventually their redemption, thereby making promotional campaigns more effective.

The invention can handle both ordinary points and promotion points. Ordinary points have an unlimited validity. Since ordinary points never expire, they will have a greater chance of being redeemed, and thus represent a greater value to the issuing business.

Promotion points can be redeemed only during a limited period of time: specifically for the duration of the corresponding promotional campaign. However, unlike traditional point systems, both ordinary points and promotion points never cease to be valid. In particular, promotion points, once the corresponding campaign's promotional period is over, become “collectible” items; nonetheless they can still be subject to any point-ownership transaction allowed by the system with the exception of redemption transactions. Therefore, such points may, for instance, be converted into other kinds of redeemable points.

By managing business-branded points and establishing a virtual marketplace for such points, the invention can also be used to predict consumer's intentions on the basis that consumers will reveal their interests indirectly by the kinds of points that they are collecting.

A further advantage of the present invention relates to the fact that it has advertising capabilities built in: being based on business's branded-points, it delivers business's own promotional messages only at a very specific point in time. Promotional messages are delivered only when a consumer gains ownership of a business's particular points. The very fact that a consumer accumulates the points of a certain brand, is indicative of his interest in that specific brand. Therefore it can be claimed that presentation of the promotional message is perceived as non-obtrusive, because it is pertinent to the points being gathered, and typically informative about further benefits.

Also, the method according to the invention can be designed to comply with privacy laws. An assumption is that the guaranteed lack of personal historical records, tracking, and profiling is much more appeasing to consumers. The method does not require personal information of any kind. Promises to consumers cannot be broken, because there are no promises to be made.

It can also be noted that the present invention, by taking advantage of technology innovations for wireless Internet-enabled mobile devices, in addition to functioning equally well in an online scenario, can also handle “real world” commerce.

Also, systems implemented according to present invention can track how points are exchanged and redeemed, and thereby establish several significant metrics (based on the dynamics of the virtual marketplace), in order to measure how effective the various promotional campaigns are. The same metrics can be used to tailor and adapt the marketing communication messages presented to individual consumers, based on their interest levels and/or speed of acquisition of the promotional values.

Furthermore, the present method is independent of any kind of point delivery vehicles. It can be applied equally well with traditional ones, as well as with the specific vehicles made possible through wireless technology.

The invention can be used so as to measure the effectiveness of marketing promotions by producing qualitative and quantitative information about consumer's inclination to make a buying decision. In addition, by applying techniques customary in stock market technical analysis, it is possible to establish predictive indicators from the collected data, and thereby enable predictive marketing.

Terminology, Notations and Nomenclature:

In order to better describe the invention, the following terms and definitions are used.

The term “M-Point” is an accounting artifact in order to establish a common base between different promotional values of different businesses. The “M” in the name M-Point carries a threefold meaning. First the point system relates to mobile devices. Secondly the point is ‘mobile’ in the sense that it can move from one consumer to another. Thirdly, the point can be converted, or morphed, from one brand into another one. Each M-Point is issued by one and only one business participating in a promotional program based on the invention. Businesses can freely define a trade commission for their own M-Points. The purpose of the trade commission is to allow companies to take advantage of the automatic co-marketing and co-/cross-marketing possibilities offered by the invention. A business can award its M-Points to consumers. Consumers can earn M-Points in several ways. Once consumers own M-Points, they can trade, barter, auction, transfer and collect them. Eventually, M-Points will be redeemed by consumers in exchange for discounts, credit or free products/services from the respective issuing business.

The term “promotional value” indicates a value provided by a business participating in a promotional program based on the invention. The exact monetary equivalent of a promotional value is defined autonomously by each participating business, since each business can define the number of M-Points needed to represent that promotional value. For example, some businesses might define the promotional value as a percentage discount on the price of their products or services. Other businesses might define the promotional value as an exact monetary amount. Others might use yet other metrics of their own. The monetary equivalent of a promotional value is what a consumer receives as a discount or free value when he is successfully taking advantage of a promotional program based on the invention.

The term “consumer” indicates an individual physical person who is enabled to collect M-Points, and who is entitled to use M-Points when purchasing products or services, and is also entitled to take part in transactions involving M-Points. In the context of the invention, a consumer is a mobile consumer, in the sense that he is equipped with a personal wireless mobile device, preferably an Internet-enabled mobile device. Typically, such a device is a cellular telephone, PDA (Personal Digital Assistant), personal computer or other functionally equivalent device. The term “business” indicates any business entity—normally in the form of a manufacturer, department store, financial institution or similar enterprise—participating in a promotional program based on the invention. A business may issue M-Points, award M-Points to consumers, initiate various promotional activities directed to the consumer, and eventually redeem the M-Points.

The term “agency” indicates any advertising agency, direct marketing company, or any other kind of marketing intermediary that can work on behalf of a business. Agencies may be allowed to interact with the system in order to define, manage and operate marketing campaigns on behalf of the participating businesses.

The term “vendor” indicates a merchant company—typically a shop, restaurant or similar company—where the consumer may redeem M-Points he has collected. Typically the vendor will recognize discount value when the consumer purchases a particular product or service at his facilities.

The abbreviation “POS” stands for “Point Of Sale”. Typically, a point of sale corresponds to a vendor's cash register desk.

The term “payment agent” indicates a bank, credit-card company or other financial institution that might be involved in the M-Point redemption process. An alternative way for consumers to redeem their M-Points is to have a monetary value equivalent to the M-Points' promotional value credited to their mobile phone account through the intermediation of the consumer's mobile operator.

The term “mobile operator” indicates a telephone company running the telecommunications infrastructure necessary for the wireless Internet-enabled mobile devices to function. Typically, such devices will be mobile phones. Mobile operators possess a billing relationship with all mobile consumers. Moreover, the mobile operators own information about the subscriber's geographic position, which facilitates the offering of location-based services.

The term “application service” indicates a Internet based computer program which is accessible (typically through a web browser) to agencies and businesses in order to allow them to interact with computer systems implementing a promotional program based on the invention. Ordinarily agencies and business will use application services to set up, configure and operate campaigns, and to establish M-Point exchange/commission percentages.

The term “wireless service” indicates a wireless Internet based computer program which is accessible (typically through a wireless Internet-enabled mobile device) to consumers. Wireless services allow consumers to interact with computer systems implementing a promotional program based on the invention. Ordinarily, consumers will use a wireless service to earn, manage, trade, barter, auction, donate, collect and spend their M-Points.

The terms “mobile device,” “mobile communication device” of just “device” refer to a consumer-owned, portable, mobile communications device, for example a mobile, handheld cellular telephone. Alternatively, the invention can be used with mobile devices in the form of personal-digital assistants (PDAs), so-called communicators, handheld portable computers connecting to a mobile network, and similar devices. The invention can be used with telematics equipped automobiles and other so-called “smart vehicles.”According to the invention, the mobile device is enabled for Internet-based communication. The mobile device is preferably of the wireless type, but the invention is not limited to such communication only.

Notation

The invention will now be described in more detail for explanatory, and in no sense limiting, purposes, with reference to the figures described hereafter.

The diagrammatic notation used in all figures is the Unified Modeling Language (UML). UML is commonly used in software engineering practices, and constitutes a means used by those skilled in the art to most effectively convey the substance of their work to others skilled in the art. UML has been standardized by the Object Management Group (www.omg.org), the largest software consortium in the world. (The OMG has a membership of over 800 companies, with participants like: 3M, IBM, Citigroup, Hewlett-Packard, Sun Microsystems, Microsoft, Fujitsu, Oracle, Bank of America, Chevron, Ford, Boeing, Lucent, Hitachi, Deere & Co, Xerox, VISA, AT&T, NT&T, and many more.)

The UML is a general-purpose visual modeling language that is used to specify, visualize, construct and documents the artifacts of a software system and related hardware. UML serves to capture decisions and understanding about software systems. It helps to understand, design, browse, configure, maintain and control information about such systems. UML gives a standard way to write a system's blueprints, covering conceptual things, such as business processes and system functions, as well as concrete things, such as classes written in a specific programming language, database schemes, and reusable software components. In the UML, you use class diagrams and component diagrams to reason about the structure of your software. You use sequence diagrams, collaboration diagrams, state chart diagrams and activity diagrams to specify the behavior of your software. You use implementation diagrams and deployment diagrams to reason about the topology of processors and hardware devices on which your software executes.

Note: in the UML diagrams used in the present application, all relevant items are identified by a unique symbolic name. In the ensuing description, we refer to diagram elements by stating within square brackets the symbolic name of the item referred to. For example: [SymbolicName].

As a further notational convention, when referring to class names in class diagrams, we mostly use the singular form; therefore when we pluralize them in the present description we may produce grammatically incorrect terms, like for example [Entry]s rather than [Entries]. The reason for this is naturally that the diagrammatic notation refers to [Entry] and not to [Entries]. Therefore in the text we refer to plurals as [Entry]s.

Nomenclature

The following symbolic names are used in the diagrams and the remainder of this document.

Account::deposit

Account::deposit

Account::getPoint

Account::point

Account::withdraw

AccountEntry

ApplicationServer

AwardTransaction

AwardTransaction::transmitConfirmationMessage

amountAvailableForAdjustment

amountToBeRedeemed

aRedeemEntry

Bluetooth

BluetoothNetwork

BrandPoint

Business::pointValue

BusinessAccount

BusinessAccount::getBusiness

BusinessComputer

BusinessDatabase

BusinessServices

buyAmount

ConsumerComputer

ConsumerServices

CoreServices

DatabaseServer

DeviceAccount

DeviceAccount::getDevice

Entry::account

Entry::amount

Entry::deposit

Entry::timestamp

Entry::withdraw

EntryDecorator

EntryDecorator::device

EntryDecorator::entry

ExchangeTransaction

fromAccount

fromAmount

fromDeviceAccount

fromMorphAccount

fromPointAccount

fromTradeCommission

fromValueMultiplier

HttpServices

IrdaNetwork

LocalAreaNetwork

MarcomAccount

MarcomEntry

MarcomEntry::calculateMarcomDebit

MarcomEntry::deposit

MarcomEntry::device

MarcomEntry::marcomDebit

MarcomEntry::marcomMessage

MarcomTransaction

MarcomTransaction::device

MarcomTransaction::execute

MarcomTransaction::marcomAccount

MarcomTransaction::marcomMessage

MarcomTransaction::personalizeMarcomMessage

MarcomTransaction::transmitMarcomMessage

MicroBrowser

MobileDevice

MobileDeviceDatabase

MorphAccount

MorphAccount::amountAvailableForAdjustment

MorphAccount::currentAdjustmentMorphEntry

MorphAccount::getAmountAvailableForAdjustment

MorphAccount::getNextAdjustmentMorphEntry

MorphAccount::getTradeCommission

MorphEntry

MorphEntry::amount

MorphEntry::calculateBuyAmount

MorphEntry::currentAdjustmentMorphEntry

MorphEntry::deposit

MorphEntry::getAmount

MorphEntry::getTradeCommission

MorphEntry::hasMorphAdjustment

MorphEntry::tradeCommission

MorphEntry::withdraw

MorphTransaction

MorphTransaction::awardTransaction

MorphTransaction::buyAmount

MorphTransaction::calculateBuyAmount

MorphTransaction::fromMorphAccount

MorphTransaction::toMorphAccount

MorphTransaction::tradeCommission

MorphTransaction::withdrawTransaction

MPointTransactionDatabase

marcomAccount

marcomMessage

MorphAccount::hasMorphAdjustment

OwnershipTransaction

OwnershipTransaction::amount

OwnershipTransaction::fromAccount

OwnershipTransaction::toAccount

PersistentStorage

Point::marcomImpressionvalue

Point::redemptionCommission

Point::tradeCommission

Point::valueMultiplier

PointAccount

PointEntry

PointEntry::pointValue

PointEntry::redemptionCommission

PointEntry::tradeCommission

PointEntry::valueMultiplier

PromoPoint

PromoPoint::valueMultiplier

Promotion::startTimepoint

Promotion::stopTimepoint

PromotionDatabase

pointvalue

RedeemAccount

RedeemAccount::createCommissionsFor

RedeemAccount::morphAccount

RedeemAccount::redeemTradeCommission

RedeemCommission

RedeemCommission::amount

RedeemCommission::redemptionDebit

RedeemCommission::redemptionValue

RedeemCommission::tradeCommission

RedeemCommission:redemptionDebit

RedeemEntry

RedeemEntry::addRedeemCommission

RedeemEntry::calculateRedeemDebit

RedeemEntry::getAmount

RedeemEntry::pointValue

RedeemEntry::redemptionCommission

RedeemEntry::tradeCommission

RedeemEntry::valueMultiplier

RedemptionTransaction

RedemptionTransaction::redeemAccount

RedemptionTransaction::withdrawTransaction

redeemAccount

redeemCommissionAmount

redeemEntry.getPointValue

redeemEntry.getRedemptionCommission

redeemEntry.getValueMultiplier

redeemTradeCommission

redemptionCommission

redemptionvalue

SymbolicName

sourcePointAccount

TradeTransaction

Transaction::execute

Transaction::execute

Transaction::initialize

TransferTransaction

TransferTransaction::transmitConfirmationMessage

targetPointAccount

toDeviceAccount

toMorphAccount

toPointAccount

toPointEntry

toValueMultiplier

tradeCommission

VendorCashRegister

VendorComputer

VendorLocalAreaNetwork

valueMultiplier

WebBrowser

WebServer

WirelessGateway

WithdrawTransaction

WithdrawTransaction::transmitConfirmationMessage

### BRIEF DESCRIPTIONS OF DRAWINGS

FIG. 01 is an Implementation Diagram that shows an overview of the physical hardware systems and devices required by the invention, their relationships and what major software components and processes they need to execute.

FIG. 02 is a Class Diagram showing the conceptual model of the system as built on branded M-Points.

FIG. 03 is a Class Diagram illustrating the class hierarchy of M-Point transactions, which are used in accordance with the invention.

FIG. 04 is a the same Class Diagram shown in FIG. 03, but with a greater amount of detail, illustrating the fundamental operations assigned to the various M-Point transaction classes.

FIG. 05 is a Class Diagram illustrating the hierarchy of M-Point accounts, their corresponding account entries, and how they are related to mobile devices and businesses.

FIG. 06 is the same Class Diagram shown in FIG. 05, but with a greater amount of detail, illustrating the fundamental operations assigned to the various M-Point account classes and account entry classes.

FIG. 07 is a Class Diagram explicating how the various M-Point transactions classes relate to the various M-Point account classes.

FIG. 08 is a Sequence Diagram revealing how a marketing communication transaction is performed.

FIG. 09 is a Sequence Diagram depicting how an M-Point award transaction is performed.

FIG. 10 is a Sequence Diagram showing how an M-Point transfer transaction is performed.

FIG. 11 is a Sequence Diagram illustrating how an M-Point withdraw transaction is performed.

FIG. 12 is a Sequence Diagram representing how an M-Point exchange transaction is performed.

FIG. 13 is a Sequence Diagram showing how an M-Point morph transaction is performed.

FIG. 14 is a Sequence Diagram detailing how an M-Point redemption transaction is performed.

FIG. 15 is a Sequence Diagram explaining how a redeem debit calculation is performed.

### DETAILED DESCRIPTION OF THE PREFERRED EMBODIMENT

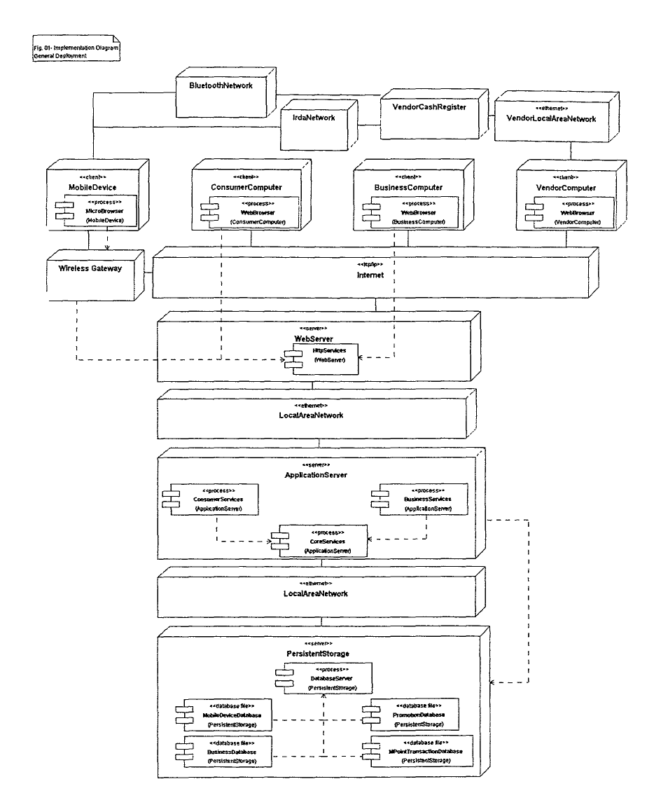

Description of Fig. 01—General Deployment

FIG. 01 is an Implementation Diagram that shows that the system will comprise at least one persistent storage node [PersistentStorage]. A persistent storage node is a computer running a database server [DatabaseServer] process. Typically the database server is an off-the-shelf relational database management system like Oracle, IBM DB2, Microsoft Sql Server, Sybase, Informix, Ingres, etc. The purpose of the persistent storage node is that of providing storage services for all other processes executing in the system. In particular, the persistent storage node will manage at least the following databases: a mobile device database [MobileDeviceDatabase] which keeps track of all mobile devices registered in the system and their respective M-Points accounts; a business database [BusinessDatabase] that keeps track of all businesses that are allowed to perform marketing promotions via the system; a promotions database [PromotionDatabase] that keeps track of all promotions performed by the businesses; and an M-Point transaction database [MPointTransactionDatabase] that keeps track of all transactions by which M-Points are awarded to consumers, change ownership, and eventually get redeemed.

The persistent storage node [PersistentStorage] is connected via a local area network [LocalAreaNetwork] to at least one application server node [ApplicationServer]. The application server node hosts a number of software based services. In particular these services are: the consumer services [ConsumerServices], and the business service [BusinessServices]. Consumer services, and business services implement the business process logic in order to allow, respectively, consumers and businesses to interact with the system. Both of these services are in turn dependent on a set of core services [CoreServices], which perform all necessary coordination, transaction processing and interfacing with the persistent storage node.

In a typical configuration, the application server node communicates via the local area network to one or more web servers [WebServer], and in particular with the hyper-text transfer protocol (http) services [HttpServices] of the web servers. The web server is connected to the Internet [Internet].

(Note: although not necessary for the actual implementation of the invention, common and sound security practices suggest the installation of adequate firewalls in between the various critical nodes. Such items are not illustrated in the diagrams. Whilst not part of the invention, it is understood that any implementation of the invention preferably will include such facilities.)

The web server communicates with a consumer's [MobileDevice]. The consumer's mobile device displays information and interacts with the consumer through a [MicroBrowser], that is an application running on the mobile device and capable of rendering http-encoded information, or any adequate transformation thereof. If necessary the communication between the web server and the consumer's mobile device can be mediated by means of a [WirelessGateway], whose purpose is that of translating http-encoded information into some other encoding format that is specific to mobile devices like, for instance, Wireless Application Protocol (WAP) or other similar protocols.

The web server also communicates with a [WebBrowser] that can be running on a personal computer or other internet enabled device and used by the various actors that might interact with the system. In particular the [ConsumerComputer] is used by a consumer in place of or in addition to a mobile device; a [BusinessComputer] is used by a business; and a [VendorComputer] is used by a vendor.

While the configuration described so far is sufficient in order to implement the invention, some additional pieces of hardware facilitate the implementation of certain functions. In particular, it is highly recommended to have in place a local area network at the vendor's outlet [VendorLocalAreaNetwork]. With such a local area network, the vendor's computer can be connected to cash registers [VendorCashRegister]. Furthermore, the cash registers can establish a connection with consumer's mobile devices through infrared communication [IrdaNetwork] or Bluetooth radio wave communication [BluetoothNetwork].

It is stressed that in FIG. 01 the invention will be implemented as software artifacts that reside primarily in the [ApplicationServer] node, and in the [CoreServices] component of the [ApplicationServer] node; and in the [PersistentStorage] node. All other nodes have a supportive function, the outcome of which results in application service provision (ASP) being delivered to businesses and wireless application service provision (WASP) being delivered to personal, internet-enabled mobile devices of individual consumers.

It should be noted that the various hardware components, such as the [PersistentStorage], the [Application server] and the [WebServer] which are shown in FIG. 1, can be implemented by means of hardware devices of standard type, i.e. device which are previously known as such.

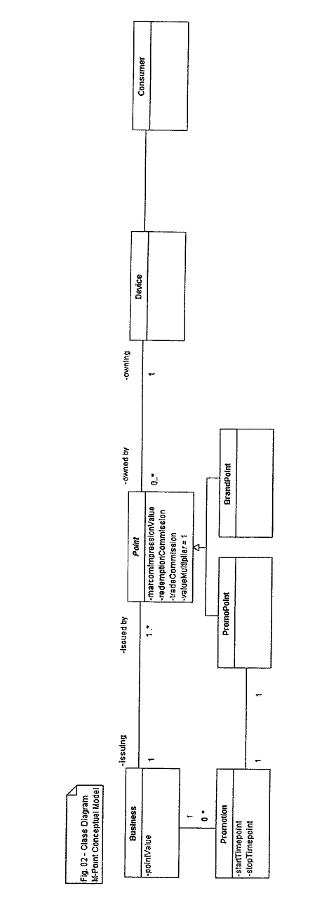

Description of FIG. 02—M-Point Conceptual Model

FIG. 02 is a Class Diagram representing a conceptual model. In particular it is shown that an M-Point [Point] is a concept modelled, represented and used by the system. It is an abstract class (it's name is written in italics). In particular each [Point] is issued by one [Business], and is owned by one [Device].

(Note: the [Device] in FIG. 02 is not to be confounded with the [MobileDevice] in FIG. 01. The latter is a physical mobile device, i.e. a piece of hardware, in the hands of consumers. The [Device] in FIG. 02 is the software representation of a [MobileDevice].)

It is vitally important to notice that a [Point] is owned by a [Device], and not directly by a consumer. It is this indirect relationship to the consumer, via his mobile device, that ensures consumer privacy. The system is concerned about mobile devices only, not about the single individuals who own them. Although the diagram shows, for the purpose of illustration, that there exists an association between a [Device] and a individual [Consumer], such association is never tracked by the system. Conceptually we know such an association exists, but in order for the system to be implemented, we do not need to (and will not) track such associations. This is how the system can guarantee compliance to privacy laws and directives.

Each [Business] is free to define the characteristic attribute [Business::pointValue], i.e. the promotional value of a single point.

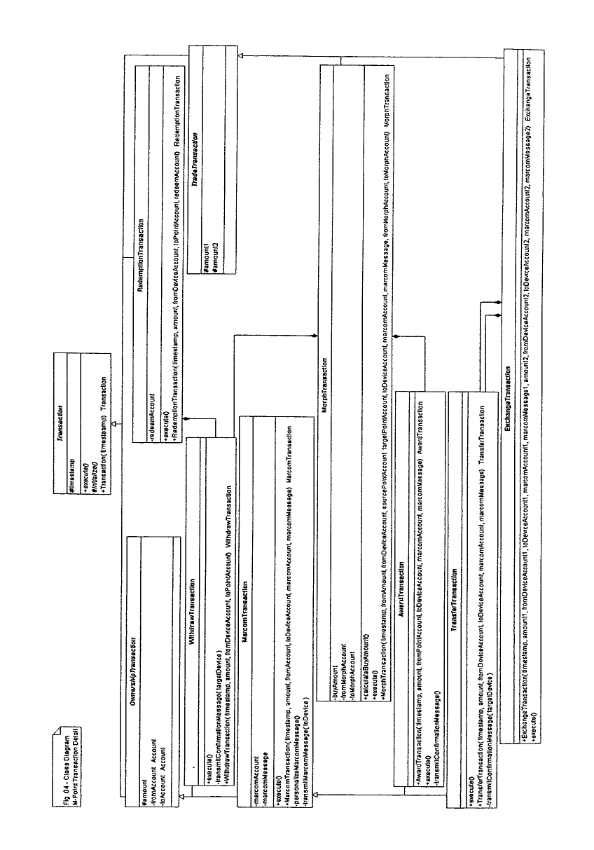

The abstract [Point] class is further classified in promotional points [PromoPoint] and brand points [BrandPoint]. Each business will be able to define one [BrandPoint], and a multitude of [PromoPoint]s (this particular aspect will be illustrated more clearly in FIG. 04). Each business will also be able to define a multitude of [Promotion]s, and each [Promotion] will be characterized by exactly one kind of [PromoPoint].

A [Point], whether it is a [BrandPoint] or a [PromoPoint], has the four attributes: [Point::marcomImpressionValue], [Point::redemptionCommission], [Point::tradeCommission] and [Point::valueMultiplier].

[Point::marcomImpressionValue] represents how much a [Busi-ness] will pay for a marketing communication impression. [Point::redemptionCommission] represents a commission, that is a percentage, on the total promotional value being redeemed by means of a redemption for that specific kind of [Point]. The [Point::redemptionCommission] is a cost to the [Business]. [Point::tradecommission] represents a commission, that is a percentage, constrained between 1 and 99 (zero and 100 are explicitly disallowed), that will be applied whenever a [Point] of the specific type is being traded, and in particular, morphed into a [Point] of another type and issued by a different [Business]. In particular, it is by virtue of the [Point::tradeCommission] attribute that an automated co-/cross-marketing facility can be established.

The attribute [Point::valueMultiplier] is always set to the value of 1 (one) for a [BrandPoint], while it can be any value greater than 0 (zero) for a [PromoPoint]. The [Point::valueMultiplier] is a multiplier that will be applied to the [Business::pointvalue] in order to compute the real value of a [PromoPoint]. The [Point::valueMultiplier] also plays a role during a morph transaction, as described later. It is, among other features, by virtue of the [Point::valueMultiplier] attribute that the system can keep promotional points valid even after the expiration of the corresponding promotion period.

A [Promotion] is characterized by a [Promotion:: startTimepoint] and a [Promotion::stopTimepoint], which define the time period during which the promotion is applicable. Notice that the period is defined at a timepoint granularity, which could be as small as the hour-minute-second-millisecond of a particular date. In other words, the system will be capable of supporting both long-lived seasonal promotions, as well as very short-lived promotions lasting only a few minutes or seconds. This is so in order to support interactive promotions that might be driven by interactive games or other kinds of time constrained interactions.

Typically a [PromoPoint::valueMultiplier] will be greater than 1 (one) until the end of the [Promotion], defined by [Promotion::stopTimepoint], and less than 1 (one) thereafter. A [Business] may also control the way [PromoPoint]s are valued by changing the [Point::tradeCommission]: typically a high trade commission will be asked for during promotions, and a lower one thereafter. Notice, in particular, that after the [Promotion]'s period terminates, the [PromoPoint] does not cease to be valid: simply it can no longer be redeemed, but it never exits the system. While [PromoPoint]s can no longer be redeemed after the promotion period, they become nonetheless collectible items. In particular, such points can still be subject to all other kinds of point ownership transactions (like transfer, morph, and exchange).

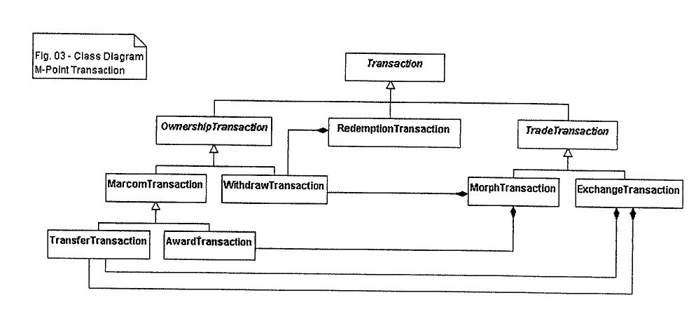

Description of FIG. 03—M-Point Transaction

FIG. 03 is a class diagram that illustrates the class hierarchy of different M-Point transactions, all represented by the base abstract class [Transaction]. This class hierarchy is an essential part of the [CoreServices] component. The purpose of this class hierarchy is to abstract and represent all possible way by which M-Points can be subject to ownership transactions in the system. In particular FIG. 03 emphasizes the relationships between the various kinds of transactions. FIG. 04 is basically the same as FIG. 03; however, in FIG. 04 the emphasis is on the attributes and operations of the single transaction classes.

The [Transaction] class hierarchy is unusual because some parts of it refer to other parts of it. We will examine how the class hierarchy is structured. In FIG. 03 it is shown that there are three broad categories of [Transaction]s: an [OwnershipTransaction], a [RedemptionTransaction] and a [TradeTransaction].

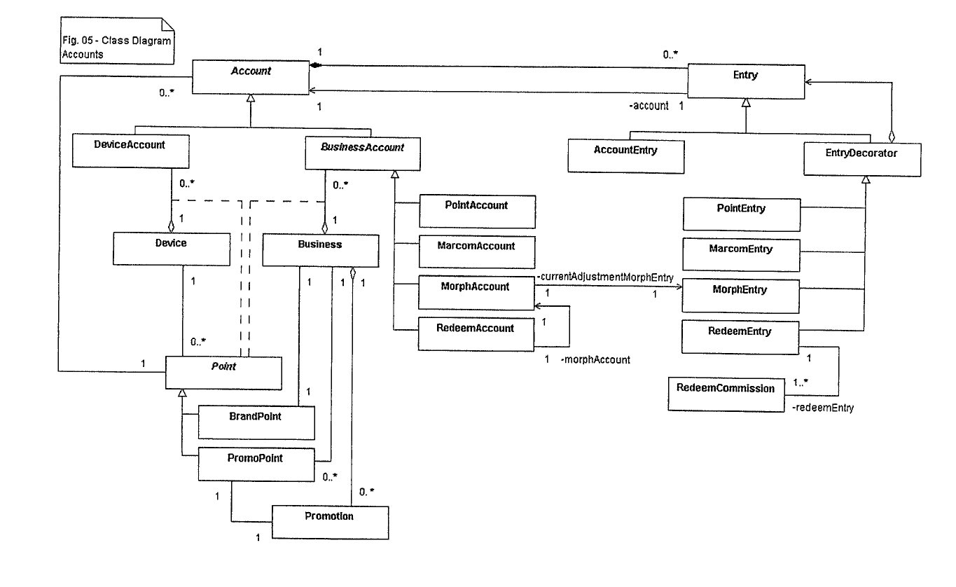

An [OwnershipTransaction] is responsible for executing the direct transferal of some M-Points from one party to another. As it will be clarified later, the transferal is actually between M-Point accounts (which are described in FIG. 05, 06 and 07). An [OwnershipTransaction] is further classified into a [MarcomTransaction] and a [WithdrawTransaction]. A [WithdrawTransaction] takes place whenever a consumer returns an amount of M-Points to a business. A [WithdrawTransaction] will never exist in isolation, but is always part of either a [RedemptionTransaction] or of a [MorphTransaction]. In other words, a [RedemptionTransaction] or a [MorphTransaction] will always create and execute a [WithdrawTransaction], as explained later.

A [MarcomTransaction], like a [WithdrawTransaction], also derives from a [OwnershipTransaction]. A [MarcomTransaction] is characterized by the fact that during its execution a marketing communication message is presented to the consumer involved in the transaction. It is primarily by virtue of the [MarcomTransaction] that the invention becomes a marketing communication delivery vehicle.

There are two classes of [MarcomTransaction]s: a [TransferTransaction] and an [AwardTransaction].

An [AwardTransaction] takes place whenever a [Business] awards an amount of [Point] s to a consumer's [Device]. There may be a variety of events that trigger an [AwardTransaction]: normally they are related to the consumer's participating in specific point-earning opportunities. In a typical (but not limiting scenario) such point earning opportunities could be: proof of purchase; proof of attendance; proof of marketing communication impression; proof of booking; proof of queuing; proof of club membership activity; proof of referral; proof of ability (for instance associated with a high-score or a win in an interactive game); proof of notification receipt. The specific reason why a point is being awarded to the consumer may vary. Preferably, such an award takes place in a transactional manner and is associated with the originating brand and (if applicable) promotion. The generic concept of an M-Point transaction is preferably used for the functioning of the whole system, and the [AwardTransaction] is generally the first link in a chain of subsequent transactions. Furthermore an [AwardTransaction] is also part of a [MorphTransaction], as described later.

A [TransferTransaction] is the second kind of [MarcomTransaction]. A [TransferTransaction] involves the transfer of an amount of [Point]s issued by one [Business] from the account of one consumer to the account of another consumer. In other words, a [TransferTransaction] is a “consumer-to-consumer” operation. For example, a [TransferTransaction] can be as simple as a [Point] donation form one consumer to another consumer. Naturally, this presumes that terms of service allow for such transfers to take place between two consumers: this is another particular aspect of the invention. Furthermore, a [TransferTransaction] can also be part of an [ExchangeTransaction]. In particular, an [ExchangeTransaction] always composes exactly two [TransferTransaction], as described later.

A [TradeTransaction] is characterized by the fact that it invariably involves two [OwnershipTransaction]s. There are two kinds of [TradeTransaction]s: the [MorphTransaction] and the [ExchangeTransaction]. Depending on the particular kind of [TradeTransaction], different kinds of [OwnershipTransaction] are involved. A [MorphTransaction] always involves exactly one [WithdrawTransaction] and exactly one [AwardTransaction]. An [ExchangeTransaction] involves exactly two (distinct) [TransferTransaction]s. It is worthwhile to remember that the [AwardTransaction] and the [TransferTransaction] are both [MarcomTransaction]s. Therefore, a [MorphTransaction] also involves (indirectly) one [MarcomTransaction]. Similarly, an [ExchangeTransaction] involves (indirectly) two [MarcomTransaction]s. The important aspect is this: during a [MorphTransaction] or an [ExchangeTransaction] the marketing communication delivery vehicle will be exercised, respectively, once or twice.

An [ExchangeTransaction] represents an exchange of [Point]s between two consumer, and therefore it is composed of exactly two distinct [TransferTransaction]s. The [ExchangeTransaction] will be described later.

A [MorphTransaction] is a particular kind of trade whereby one consumer converts [Point]s of one kind (and issued by one [Business]) into [Point] of another kind (and issued by another [Business]). The [MorphTransaction] is so called because from the point of view of the consumer, the original [Point]s will have “morphed” into another kind of [Point]s.

The execution of a [MorphTransaction] has three significant results. First, the consumer earns the kind of [Point]s he's most interested in, and therefore he or she will be closer to maturing a buying decision.

Second, the [Business] whose [Point]s are given to the consumer will have gained a tangible marketing results from marketing efforts of the original [Business].

Third, the original [Business] will have turned a (potential) promotional expense into (concrete) direct revenue: in other words, a dead promotion turns into a profit.

In order for all this to work, a [MorphTransaction] has a cost involved: it is the [Point::tradeCommission] of the original, source [Point]s. The consumer will pay this cost in terms of a corresponding percent reduction in the amount of target [Point]s he will receive at the end of the [MorphTransaction].

The [Business] that originally issued the source [Point]s will receive a compensation as a consequence of the [MorphTransaction]. This compensation is preferably gathered at the next occasion (i.e. future occasion with respect to the moment in time when the [MorphTransaction] takes place) there is a [RedemptionTransaction] for that same kind of [Point] and up to that same amount. In particular the compensation takes the form of percent reduction equal to the original [point::tradeCommission] applied on the actual [Point::redemptionCommission].

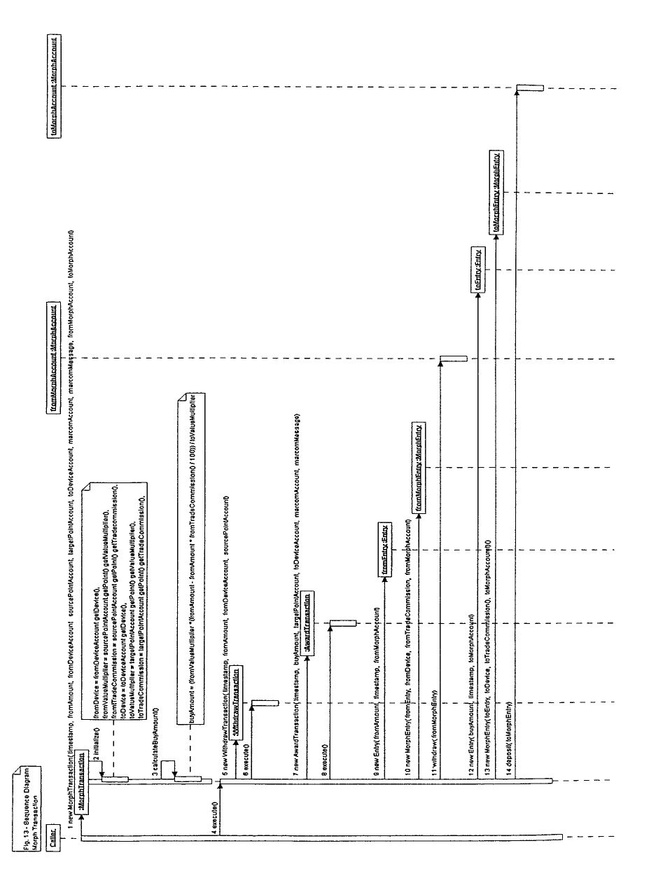

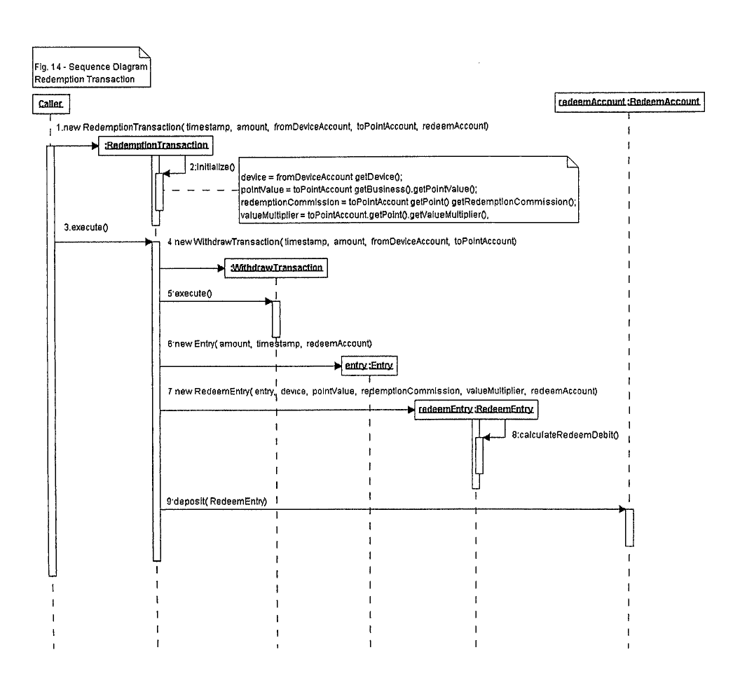

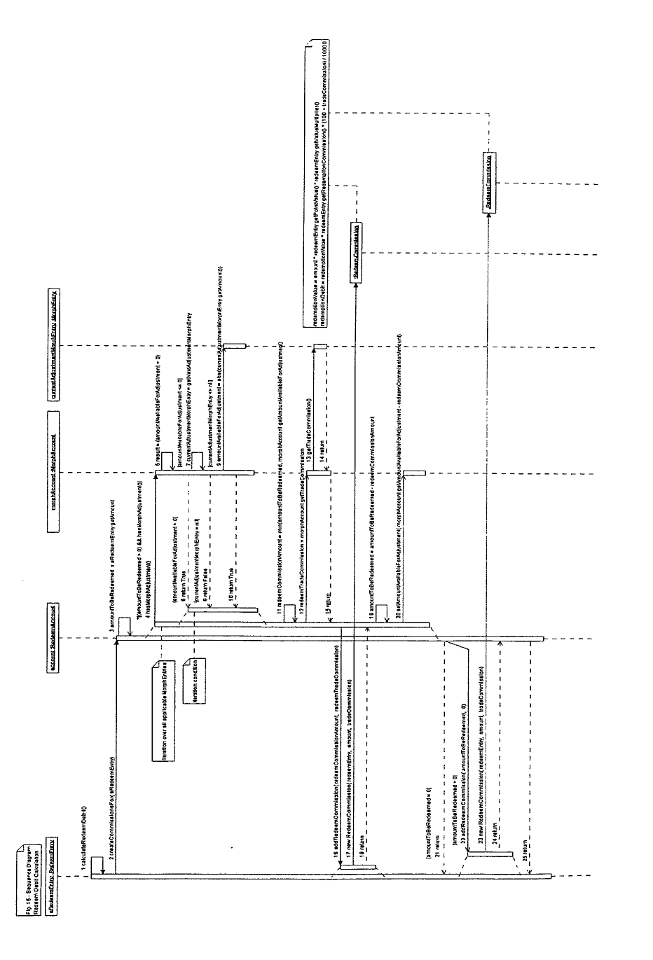

Similarly, for the target [Business] whose [Point]s are given to the consumer, there will be a cost in terms of a percent increase equal to the target [Point::tradeCommission] applied to the actual [Point::redemptioncommission]. The actual mechanics and formulas for these calculations are described later in FIG. 13, FIG. 14 and FIG. 15.

The [MorphTransaction], together with the [RedemptionTransaction], is used for enabling the virtual marketplace of promotional values, and allowing businesses to perform automatic co-/cross-marketing. It is important to note that this works precisely due to the fact that all [Point]s are branded by the [Business] that issued them. In other point systems where the points are not branded, this is simply not possible. The branding of the points allows the establishment of a virtual marketplace of promotional values.

It is also important to notice that by means of the asymmetric trade commissions being applied to the [Business] end-points of a [MorphTransaction], the system enables automatic co-/cross-marketing but without any direct billing relationships between any two [Business]es involved.

Furthermore, since all compensations/charges are actually handled as a percent reduction/increase on redemption commissions that happen in the future, there is no need to manage such compensations/charges in terms of actual monetary values. From the point of view of the original [Business]s whose [Point]s are being morphed from, there has been no cost at all in the operation, but only a (potential) compensation that can be gathered on a (future) redemption. Keep in mind that the original [Business] has already had the benefit of the [MarcomTransaction] originally involved in awarding those points to the consumer in the first place.

From the point of view of the target [Business] whose [Point]s are being morphed to, there is the immediate benefit of delivering a marketing communication message (via the implied a [MarcomTransaction]), and the tangible result of gaining the knowledge that the involved consumer has a keen interest in those [Point]s. For the target business, the cost for this extra (current) knowledge is paid on a (future) redemption, and as a percentage increase on a redemption commission. In other words, this cost is computed as a percentage on a percentage, and hence very affordable.

It is important to notice that the redemption commission is usually subject to negotiation between the businesses and the service provider of the system. However, each business is free to autonomously define the trade commission, and to change that value at any time. In this way, a business can make certain points more or less attractive (for consumers) to acquire or to relinquish. In particular, this value can be set at different levels for [PromoPoint]s during a promotion and after the promotion's end.

A [RedemptionTransaction] takes place when one consumer redeems a certain amount of [Point]s for the corresponding promotional value. For this reason, a [RedemptionTransaction] is invariably associated with a [WithdrawTransaction]. A [RedemptionTransaction] is characterized by the fact that it will also calculates the charges debited to the [Business] whose [Point]s are involved in the redemption, as described later in FIG. 14 and FIG. 15. Since charges are accrued at the time of redemption, this is how [Business]es can be charged on a pay-for-performance basis. When a consumer redeems his points, it is an indisputable evidence that the promotion has fulfilled its purpose, and therefore there is reason to charge.

Description of FIG. 04—M-Point Transaction Detail

FIG. 04 is basically the same as FIG. 03; however, in FIG. 04 the emphasis is on the attributes and operations of the single transaction classes, rather than on the relationships amongst themselves. Also, for each class the constructor operation and signature is shown.

(Note: The constructor operation is used to build an instance of a class. The constructor operation has the same name as the class wherein it appears. The constructor signature is the list of parameters that are used to invoke the constructor.)

Hereafter follows a description of the most significant attributes and operations.

The [Transaction] class has a [Transaction::timestamp] attribute. This attribute represents the moment in time when the transaction is enacted. There is also a virtual abstract [Transaction::execute( )] operation, the invocation of which will actually make the transaction take place. And finally, there is a virtual abstract protected [Transaction::initialize( )] operation, which is used during a [Transaction]'s construction phase to initialize any helper member variables that might be needed. (Note: in the diagram, overridden [::initialize( )] operations are not shown: we assume they are defined where needed.) Since the [Transaction] class is the base class of the transaction hierarchy, these attributes and operations will be common to all other transactions.

The [OwnershipTransaction] has the [OwnershipTransaction:: amount] attribute to store the amount of [Point]s being transacted. Also the [OwnershipTransaction] keeps two references to accounts, the [OwnershipTransaction::fromAccount] and the [OwnershipTransaction::toAccount], respectively the source and the target of the [Point]s being transacted.

The [WithdrawTransaction] has the operation [WithdrawTransaction::transmitConfirmationMessage( )] in order to transmit a confirmation message to the [Device] from whose account [Point]s have been withdrawn. Naturally, a [WithdrawTransaction] also inherits all attributes and operations present in its ancestor classes: the [OwnershipTransaction] and the base [Transaction].

The [MarcomTransaction] holds onto a reference to a marketing communication account via the attribute [MarcomTransaction::marcomAccount]. This account is used for bookkeeping purposes, and registers the charges to the [Business] for advertising the marketing communication message. Also the marketing communication message itself is stored in the attribute [MarcomTransaction::marcomMessage]. The [MarcomTransaction] has the operation [MarcomTransaction::transmitMarcomMessage( )] in order to transmit the marketing communication message to the [Device] whose account [Point]s are being transferred to. Naturally, a [MarcomTransaction] inherits all features of its ancestor classes: the [OwnershipTransaction] and the base [Transaction].

An [AwardTransaction] has all features of a [MarcomTransaction]. Furthermore it has the operation [AwardTransaction::transmitConfirmationMessage( )] in order to transmit a confirmation message to the [Device] to whose account [Point]s are being transferred to.

A [TransferTransaction] has all features of a [MarcomTransaction]. Furthermore it has the operation [TransferTransaction::transmitConfirmationMessage( )] in order to transmit a confirmation message both to the [Device] whose account [Point]s are being transferred to, as well as to the [Device] whose account [Point]s are being transferred from.

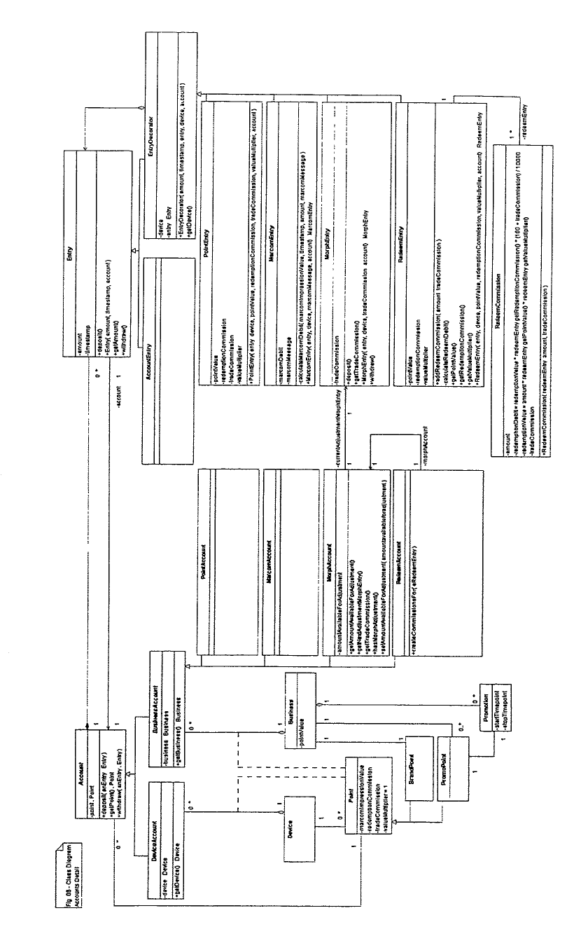

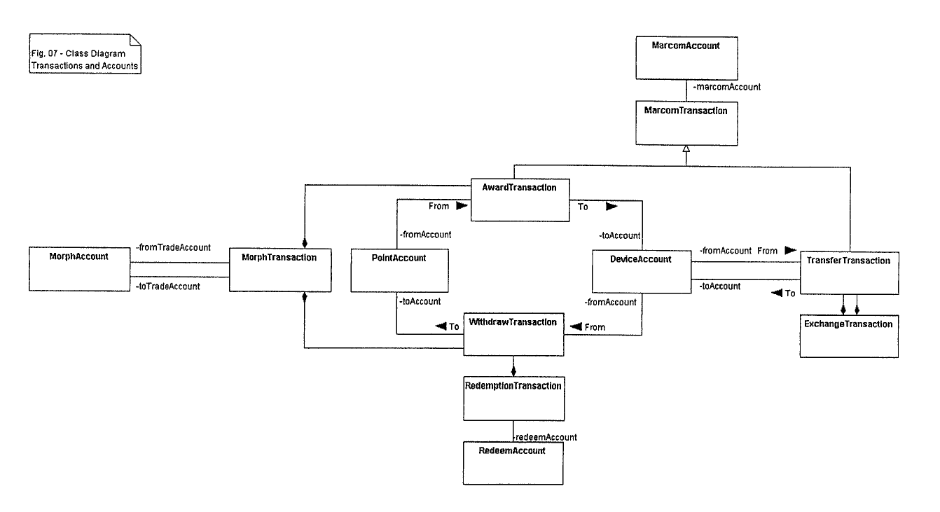

While a [WithdrawTransaction], an [AwardTransaction] and a [TransferTransaction] might appear to be similar, in reality they differ in the way the inherited attributes [OwnershipTransaction::fromAccount] and [OwnershipTransaction::toAccount] are set up. The principal difference is revealed in their respective constructor signatures. A [WithdrawTransaction] will have its inherited [OwnershipTransaction::fromAccount] attribute referencing a [DeviceAccount], and its inherited [OwnershipTransaction::toAccount] attribute referencing a [PointAccount]. (Note: the account classes have not yet been introduced: they are described later in FIG. 05, FIG. 06 and FIG. 07). An [AwardTransaction] will have its inherited [OwnershipTransaction::fromaccount] attribute referencing a [PointAccount], and its inherited [OwnershipTransaction::toAccount] attribute referencing a [DeviceAccount]. A [TransferTransaction] will have both its inherited [OwnershipTransaction::fromAccount] attribute and its inherited [OwnershipTransaction::toAccount] attribute referencing a two distinct [DeviceAccount]s. (Naturally, the [AwardTransaction] and the [TransferTransaction], being both a [MarcomTransaction], will also have an inherited [MarcomTransaction::marcomAccount] referencing a [MarcomAccount].)

A [RedemptionTransaction] has the attribute [RedemptionTransaction::redeemAccount] in order to hold onto a reference to a [RedeemAccount]. Also, implied by the compositional notation towards a [WithdrawTransaction], there is the attribute [RedemptionTransaction::withdrawTransaction] that holds onto a reference to the [WithdrawTransaction] that will materially execute, on behalf of the [RedemptionTransaction], the [Point] transfer from a [DeviceAccount] to a [PointAccount]. A [TradeTransaction] has two amount attributes: [TradeTransaction::amount1] and [TradeTransaction::amount2]. Since a [TradeTransaction] invariably involves two [OwnershipTransaction]s, said two amounts are assigned respectively to one or the other of the two [OwnershipTransaction] s.

A [MorphTransaction] inherits all features of its ancestor classes: [TradeTransaction] and [Transaction]. A [MorphTransaction] has two attributes implied by the compositional notation: [MorphTransaction::withdrawTransaction] and [MorphTransaction::awardTransaction], which hold onto a reference, respectively, to a [WithdrawTransaction] and to an [AwardTransaction]. The central responsibility of a [MorphTransaction] is that of transforming an amount of [Point]s of one kind into a (generally) different amount of [Point]s of another kind. The second amount is represented by the [MorphTransaction::buyAmount] attribute. The responsibility of calculating the [MorphTransaction::buyAmount] is done by the operation [MorphTransaction::calculateBuyAmount( )]. The way the calculation is performed will be described in greater detail in FIG. 13. What is important to notice here is that the [MorphTransaction] also holds onto another pair of references: the [MorphTransaction::fromMorphAccount] and the [MorphTransaction::toMorphAccount]. The two referenced [MorphAccount]s are used in order to register the trade commission that will be, respectively, credited or debited to the two [Business]es whose [Point]s are involved in the [MorphTransaction].

It is specifically by virtue of the operation [MorphTransaction::calculateBuyAmount( )] that automatic co-/cross-marketing operations become possible. Said calculation transforms (i.e. “morphs”) promotional values issued by one business into promotional values issued by another business. Every time a [MorphTransaction] is enacted, then, from a conceptual standpoint, an inter-business trade commission is accrued.

An [ExchangeTransaction] inherits all features of its ancestors: [TradeTransaction] and [Transaction]. An [ExchangeTransaction] composes two [TransferTransaction]s, and therefore has two attributes implied by the compositional notation: [ExchangeTransaction::transferTransaction1] and [ExchangeTransaction::transferTransaction2], which hold onto a reference, respectively, to the first and the second [TransferTransaction].

An [ExchangeTransaction] is the basis for allowing bartering, auctioning or other types of exchange of [Point]s of different kinds between two consumer's mobile [Device]s. Naturally, this presumes that terms of service allow for such barters, auctions and exchanges to take place between consumers: this is another particular aspect of the invention.

Description of FIG. 05—Accounts

FIG. 05 is a class diagram that illustrates the class hierarchy of different M-Point accounts, all represented by the base abstract class [Account]. This class hierarchy is also an essential part of the [CoreServices] component. The purpose of this class hierarchy is to abstract and represent all possible ways [Point]s can be accounted for. There are two main classes of [Account]S: the [DeviceAccount] and the [BusinessAccount]. The [BusinessAccount] is further specialized into the four classes: [PointAccount], [MarcomAccount], [MorphAccount] and [RedeemAccount]. It is important to notice how a [DeviceAccount] and a [BusinessAccount] relate, respectively, to a [Device] and a [Business]. Each [Device] can have zero or more [DeviceAccount]s. Each [Business] can have zero or more [BusinessAccount]s. In both cases the relationship is an attributed relationship, where the attribution is determined by a specific [Point]. (The two attributed relationships are represented on the diagram by the two dashed lines outgoing from the [Point] class).

This means that a [Device] can have one and only one [DeviceAccount] for each kind of [Point], where [Point] might be any kind of M-Point issued by any [Business].

Similarly, a [Business] can have one and only one specific [BusinessAccount] for each kind of [Point] issued by that very same [Business]. Here, by “specific” we intend any concrete instance of a [BusinessAccount] subclass. Furthermore, each business can issue one and only one [BrandPoint], while it can issue as many [PromoPoint] as it defines [Promotion]s. In other words, if a [Business] issues its [BrandPoint], then it can have at most one [PointAccount], one [MarcomAccount], one [MorphAccount] and one [RedeemAccount] each attributed by that [BrandPoint]. Likewise, for each [PromoPoint] issued by the [Business], the [Business] can have at most one [PointAccount], one [MarcomAccount], one [MorphAccount] and one [RedeemAccount] each attributed by the [PromoPoint].

It is in virtue of this attributed relationship that the system can handle a multitude of different points, and thereby create a virtual marketplace of branded promotional values. Not only does it handle points issued by different businesses, but also points issued for the purpose of different promotions by different businesses.

Each [Account] has zero or more [Entry]s. As it will be further explained in FIG. 06, an [Entry] registers an amount and a timestamp, respectively, via the attributes [Entry::amount] and [Entry::timestamp]. Naturally, the amounts being registered are amounts of [Point]s corresponding to the [Point] accounted for by the [Account] to which the [Entry] belongs. Each [Entry] is knowledgeable about which [Account] it belongs to, by means of the implied attribute [Entry::account].

All concrete [BusinessAccount] subclasses have the need to register additional information (that is, in addition to the amount and the timestamp). For this reason a decorator pattern is used. Ordinary entries are represented by the [AccountEntry] subclass. Typically, an [AccountEntry] belongs to a [DeviceAccount]. An [EntryDecorator] subclass is defined in order to host any additional information. Notice that an [EntryDecorator] holds onto a reference to the original [Entry] that it is actually decorating with the extra information. (More about this in FIG. 06.) In particular from the [EntryDecorator] we derive the following four decorator subclasses: [PointEntry], [MarcomEntry], [MorphEntry] and [RedeemEntry]. A [PointEntry] decorates an [Entry] with additional information pertinent to a [PointAccount]. A [MarcomEntry] decorates an [Entry] with additional information pertinent to a [MarcomAccount].

A [MorphEntry] decorates an [Entry] with additional information pertinent to a [MorphAccount]. A [RedeemEntry] decorates an [Entry] with additional information pertinent to a [RedeemAccount].

In particular a [RedeemEntry] is always associated with one or more instances of a [RedeemCommission] class. The [RedeemCommission] records all or part of the commission debit that a [Business] has accrued for a [RedemptionTransaction] pertaining to some of its [Point]s. The way [RedeemCommission]s are calculated and created is explained in FIG. 14 and FIG. 15. For the moment, suffice it to say that there are a couple of navigable associations that are used for said calculation. First, each [RedeemAccount] is knowledgeable about which [MorphAccount] (if any) has records about any outstanding [MorphTransaction]s that need to be debited or credited. This association is represented by the implied attribute [RedeemAccount::morphAccount]. Such a [MorphAccount] will in turn be knowledgeable about the latest outstanding [MorphEntry], via the implied attribute [MorphAccount::currentAdjustmentMorphEntry].

Description of FIG. 06—Accounts Detail

FIG. 06 is basically the same as FIG. 05; however, in FIG. 06 the emphasis is on the attributes and operations of the single account and entry classes, rather than on the relationships amongst themselves. Also, for some classes the constructor operation and signature is shown. An [Account] is knowledgeable about the [Point] that it relates to via the [Account::point] attribute. An [Account] is also capable of providing this piece of information via the [Account::getPoint( )] getter operation. Each [Account] has an [Account::deposit( )] and an [Account::withdraw( )] operation. Both of these two operations take as a parameter an [Entry], and their main purpose it that of adding the [Entry] specified as their parameter the [Account]'s internal ordered collection of [Entry]s.

In turn, the [Account::deposit( )] and an [Account:: withdraw( )] operations will invariably invoke, respectively, the [Entry::deposit( )] and [Entry:: withdraw( )] operations of their [Entry] parameter. Note that this is a common pattern (which we will not necessarily state explicitly hereafter, but which nonetheless we will always imply any time an [Account:: deposits] or an [Account::withdraw( )] operation is represented in the subsequent diagrams).

Each [DeviceAccount] is knowledgeable about the [Device] that it belongs to. Each [DeviceAccount] is capable of providing this piece of information via the [DeviceAccount::getDevice( )] getter operation.

Each [BusinessAccount] is knowledgeable about the [Business] that it belongs to. Each [BusinessAccount] is capable of providing this piece of information via the [BusinessAccount::getBusinesso] getter operation.

As mentioned earlier, each [Entry] records an [Entry:: amount] and an [Entry::timestamp]. An [Entry], once created, is conceptually considered immutable. Notice that an [Entry] expects to receive the [Account] to which it is to be associated via its constructor. An [Entry] defines the two operations [Entry::deposit( )] and [Entry:: withdraw( )]. These two operations will carry out at least two tasks. First they will ensure that the [Entry::amount] attribute is give the sign appropriate for the operation: i.e. positive for a deposit, and negative for a withdrawal. Second they will make sure that the entry is permanently stored into persistent storage.

An [AccountEntry] is just a logical specialization of an [Entry], but in terms of internal structure does not differ from an [Entry].

An [EntryDecorator] is used to add additional information to [Entry]s that will be associated with any kind of [BusinessAccount]. In particular an [EntryDecorator] keeps track of the [Entry] it is adding information to via the [EntryDecorator::entry] attribute.

Also, as mentioned, an [EntryDecorator] is associated with the appropriate [BusinessAccount]. (In more precise terms: an [EntryDecorator] references an [Entry] which in turn is associated with an [Account], and this [Account] can be a [BusinessAccount]. The actual business logic will ensure that an [EntryDecorator] is associated with a [BusinessAccount].) The [EntryDecorator] will have been created by some [Transaction] between the [Business] owning that [BusinessAccount], and some consumer's [Device]. It is important for each [EntryDecorator] to know which [Device] originated the [Transaction]. In order to provide for this knowledge, there exists the [EntryDecorator::device] attribute. Values for both the [EntryDecorator::entry] and the [EntryDecorator::device] are expected as parameters in the [Entry]'s constructor. In other words, when the a [Transaction] creates and [EntryDecorator] to be added to some [BusinessAccount], the [Transaction] must know which [Device] was involved and which basic [Entry] is being extended by means of the decoration.

It is by virtue of the [EntryDecorator::device] attribute that it is possible to relate to the originating [Device] and thereby provide interesting data for driving the promotions executed through the system. The [Entry::amount] of any given [Transaction] can be assumed as a direct measure of the level of interest that a consumer has for the associated [Point] or [Promotion]. Also, by relating this to the time-series of earlier [Transaction]s of the same kind, it is possible to measure how this interest develops throughout the time dimension. Further marketing communication messages can be construed by taking into consideration recency, frequency, and volumes of such [Transaction]s. The innovative aspect is the ability to have a direct measure of the level of interest of consumer in specific promotions; and also to be able to understand how this interest moves from one promotion to another, and/or from one brand to another.

Another important consequence is that the system does not primarily promote “loyalty” per se (as other loyalty systems intend to do). An important purpose is to enable any promotional value to quickly reach the consumer that is most likely to want to take advantage of it: in other words, the system is designed to accelerate and amplify the effects of a promotional campaign.

A [PointEntry] decorator is characterized by the four attributes: [PointEntry::pointvalue], [PointEntry::redemptioncommission], [PointEntry::tradeCommission] and [PointEntry::valueMultiplier]. These four attributes register, respectively, the values of the [Business::pointValue], [Point::redemptionCommission], [Point::tradeCommission] and [Point::valueMultiplier] of the involved [Business] and [Point] at the time when the [Transaction] was enacted, time which is in turn stored in the decorated [Entry]'s [Entry::timestamp] attribute. The reason why these values are registered in the [PointEntry] attribute is that they can change during the course of time. Therefore, for historical exactness, it is necessary to register the current values at the moment in time when the [Transaction] that created the [PointEntry] was enacted.

Note: A [Business] is free to determine and change at any moment its [Business::pointValue], [Point::tradeCommission] and [Point::valueMultiplier]. This is one way in which a [Business] can effectively tune promotion parameters. The [Point::redemptionCommission] is set and changed by the terms of service between the [Business] and the service provider, and therefore it can also change during the course of time.

A [MarcomEntry] decorator stores the two attributes: [MarcomEntry::marcomDebit] and [MarcomEntry::marcomMessage]. A [MarcomEntry] records the fact that a marketing communication message, the [MarcomEntry::marcomMessage], has been delivered to a consumer's [Device]. A [MarcomEntry] is capable of calculating how much this marketing communication message will cost the [Business]. This capability is represented by the [MarcomEntry:: calculateMarcomDebit( )] operation, and the result of this calculation is stored for future billing to the [Business] in the [MarcomEntry::marcomDebit] attribute. It is important to notice that the calculation is a function of the [Point::marcomImpressionValue], and this value is set and changed by the terms of service between the [Business] and the service provider; therefore it can change during the course of time. The reason why the actual marketing message is recorded in [MarcomEntry::marcomMessage] attribute is that the message is not unique: as it was stated a promotion can be driven by various parameters, not the lest the measurement of a consumer's level of interest. Therefore, at the same moment of time, different consumers, which are characterized by different interest level parameters, can receive different marketing communication messages. While the consumer remains anonymous behind his [Device], nonetheless this is how the promotion can be personalized according to different interest levels.

A [MorphEntry] decorator has the attribute [MorphEntry: tradeCommission]. This attribute registers the value of the [Point::tradeCommission] of the involved [Point] at the moment in time when the [Transaction] was enacted. Again this is done for historical exactness, since the [Business] is allowed to change the [Point::tradeCommission] at any moment. The value of [MorphEntry::tradeCommission] is used in the calculation of future redemption commissions. Therefore it is made available for other parts of the system via the [MorphEntry::getTradeCommission( )] getter operation.

Notice that the [MorphEntry] overrides the [Entry:: deposit( )] and [Entry::withdraw( )] operations. The reason for doing this is that the [MorphEntry::deposit( )] and [MorphEntry::withdraw( )] operations, in addition to performing the functions of their respective inherited operations, will also ensure that the [MorphEntry::tradeCommission] attribute is given the same sign as the entry's amount, i.e. positive for a deposit and negative for a withdraw. The reason for giving a sign to the [MorphEntry::tradeCommission] is that this will simplify subsequent calculations (specifically, those described in FIG. 15, Step 17 and Step 23.)

A [RedeemEntry] decorator is characterized by the three attributes: [RedeemEntry::pointValue], [RedeemEntry::redemptioncommission], and [RedeemEntry::valueMultiplier]. These three attributes register, respectively, the values of the [Business::pointValue], [Point::redemptionCommission], and [Point::valueMultiplier] of the involved [Business] and [Point] at the time when the [Transaction] was enacted.

A [RedeemEntry] is added to a [RedeemAccount] by a [RedemptionTransaction] whenever a consumer redeems some amount of [Point]s. Since this is the indisputable evidence that the promotion has fulfilled its purpose, the creation of a [RedeemEntry] is invariably and contextually tied to debiting the [Business] for the result achieved. The price paid by a [Business] for any redemption corresponds, ordinarily, to the [Point::redemptionCommission] percentage of the value given by the amount of [Point]s being redeemed, multiplied by the corresponding [Business:: pointValue], multiplied by the corresponding [Point::valueMultiplier]. However, if the [Business] has in some way benefited from the fact that some [Point]s might have been gained or relinquished due to one or more [MorphTransaction]s, then such percentage will have to be adjusted according to one or more [MorphTransaction::tradecommission]s.

Naturally the amount of [Point]s subject to this adjustment must correspond to the number of [Point]s exchanged through such one or more [MorphTransaction]s. Now, the amount of [Point]s recorded in a [RedeemEntry] can be less, equal or greater than the amount of [Point]s recorded in a single [MorphTransaction]. In order to deal with the different correspondences, each [RedeemEntry] will split down the calculation of the redeem debit in one or more [RedeemCommission]s. A single [RedeemCommission] represents all or part of a redeem debit. The attribute [RedeemCommission:: redemptionDebit] represents the monetary debit of each single [RedeemCommission]. The [RedeemEntry] class has the capability of creating the set of [RedeemCommission]s and their corresponding [RedeemCommission::redemptionDebit] by means of the [RedeemEntry::calculateRedeemDebit( )] operation.

The [RedeemEntry::calculateRedeemDebit( )] operation collaborates with the [RedeemEntry]'s associated [RedeemAccount]. As a matter of fact [RedeemEntry::calculateRedeemDebit( )] delegates it's duties to the [RedeemAccount] class, through the [RedeemAccount::createCommissionsFor( )] operation, to which the [RedeemEntry] passes itself as the sole parameter in order to implement a callback. The [RedeemAccount] will in turn collaborate with corresponding [MorphAccount] class, indicated by the [RedeemAccount:: morphAccount] implicit reference attribute.

Each [MorphAccount] holds onto a time-ordered collection of [MorphEntry]s, each having its own [MorphEntry::tradeCommission]. Whenever the [RedeemAccount] needs to create [RedeemCommission]s on behalf of one of its [RedeemEntry]s, it will ask its corresponding [MorphAccount] if there are any [MorphEntry]s to be accounted for. This is done via the [MorphEntry::hasMorphAdjustment( )] query operation. If the answer is negative, then a single [RedeemCommission] will be created wherein the [RedeemCommission:redemptionDebit] is calculated directly, as described above. However if there are [MorphEntry]s to be the taken into account, then the [RedeemAccount] will ask its corresponding [MorphAccount] to examine the latest [MorphEntry] that has not yet been fully used for calculating a redemption debit. A [MorphAccount] is knowledgeable about this particular [MorphEntry] via the implied [MorphEntry::currentAdjustmentMorphEntry]. Furthermore, if the amount of [Point] s in that particular [MorphEntry] can be used only partially in order to create a [RedeemCommission], then the [MorphAccount] is able to remember how many points are available for the next time the operation is requested: this amount is stored in the [MorphAccount::amountAvailableForAdjustment] attribute. As soon as the [RedeemAccount] has calculated the redemption debit, it can create a [RedeemCommission] and invoke the [RedeemEntry::addRedeemCommission( )] operation. Notice that the [RedeemCommission] will record how many [Point]s where actually part of the computation via the [RedeemCommission::amount] attribute. The [RedeemCommission::tradeCommission] attribute will record what trade commission was actually applied (i.e. the trade commission originated from a [MorphEntry] according to the above process). The [RedeemCommission:: redemptionvalue] will store the base monetary value (i.e. amount*[Business::pointValue]*[Point::valueMultiplier]) of the computation. To be precise, in this expression: the [Business::pointValue] is actually taken chronologically at the time of creation of the corresponding [RedeemEntry], and thus is taken from [RedeemEntry::pointValue]. Similarly, the [Point::valueMultiplier] is taken from [RedeemEntry::valueMultiplier].

Finally the [RedeemCommission::redemptionDebit] will store the charge debited to the [Business]. This charge is preferably computed according to the expression: [RedeemCommission::redemptionValue]* [Point::redemptionCommission]*(100+[Point::tradeCommission])/10000. Again to be precise, in this expression, the [Point::redemptioncommission] is taken from [RedeemEntry::redemptionCommission], and [Point::tradeCommission] is taken from the [MorphEntry::tradeCommission] stored in [RedeemEntry::tradeCommission]. Note also that the [RedeemEntry::tradeCommission] can be both positive or negative, depending on whether the originating [MorphTransaction] acquired or relinquished [Point]s.

All of the above is fairly complex. An accurate description of the computational mechanics is presented later in FIG. 14 and FIG. 15. According to the embodiment, these computations are used so that the virtual marketplace is enabled, and so that a [Business]'s co-/cross-marketing activities are being paid for as an increase/decrease in (future) redemption commissions. This is also how a direct billing relationship between two different [Business]es can be avoided, and intermediated instead.

Description of FIG. 07—Transactions and Accounts

FIG. 07 is a class diagram that illustrates how [Transaction]s and [Account]s relate to each other. In particular, it is important to note how a [Transaction] always generates at least a couple, if not multiple, [Entry]s in two or more [Account]s. In particular, FIG. 07 represents which [Account]s are used by the various [Transaction]s.

An [AwardTransaction] will always transfer an amount of [Point]s from a [PointAccount] to a [DeviceAccount]. Consequently a [PointEntry] will be withdrawn from a [PointAccount] and an [AccountEntry] will be deposited in a [DeviceAccount].

A [TransferTransaction] will always transfer an amount of [Point]s from a [DeviceAccount] to another [DeviceAccount]. Consequently an [AccountEntry] will be withdrawn from the first [DeviceAccount], and another [AccountEntry] will be deposited in the second [DeviceAccount].

Both the [AwardTransaction] as well as the [TransferTransaction] are a [MarcomTransaction]; therefore, in addition to what has been described in the above paragraphs, they also behave like a [MarcomTransaction]. A [MarcomTransaction] will always deposit a [MarcomEntry] in a [MarcomAccount].

An [ExchangeTransaction] is simply composed of two [TransferTransaction]s. So an [ExchangeTransaction] entails that four [DeviceAccount]s are being updated: two will have [AccountEntry]s deposited, and two will have [AccountEntry]s withdrawn. Furthermore, the two [TransferTransaction]s also behave as two [MarcomTransaction]s, and therefore two (distinct) [MarcomEntry]s will be deposited in two (distinct) [MarcomAccount]s.

A [WithdrawTransaction] will always transfer an amount of [Point]s from a [DeviceAccount] to a [PointAccount]. Consequently an [AccountEntry] will be withdrawn from a [DeviceAccount], and a [PointEntry] will be deposited in a [PointAccount].

A [RedemptionTransaction] always includes a [WithdrawTransaction]. In addition to the [Account]s and [Entry]s involved by the [WithdrawTransaction], the [RedemptionTransaction] always deposits a [RedeemEntry] in a [RedeemAccount]. (And, as described earlier, this implies the creation of one or more [RedeemCommission]s.)

A [MorphTransaction] is composed of a [WithdrawTransaction] and an [AwardTransaction] (which is, in turn, a [MarcomTransaction]). In addition to all the [Account]s and [Entry]s involved in a [WithdrawTransaction], an [AwardTransaction], and a [MarcomTransaction], the [MorphTransaction] will also withdraw a [MorphEntry] from a [MorphAccount], and deposit a second [MorphEntry] in a second [MorphAccount]. Notice that, due to the effect of the trade commission, the amount deposited in the second [MorphAccount] is (generally) different than the amount withdrawn from the first [MorphAccount]; however this is also affected by the conversion factor given by the ratio of the two [::valueMultiplier]s.

Due to the inheritance and composition relationship among the various [Transaction]s, the system implements a tightly knit transactional engine with seven classes of [Transaction]s. This simple model provides several advantages as regards promotional systems. It realizes a targeted marketing communication delivery vehicle via the [MarcomTransaction]. It allows for various kind of transfer of ownership of promotional values between consumers via the [TransferTransaction] and the [ExchangeTransaction]. It enables an ongoing an automatic co-/cross-marketing activity between different businesses via the [MorphTransaction]. All charges to [Business]s are accounted for by the [MarcomTransaction] the [RedemptionTransaction]. Furthermore the [RedemptionTransaction] allows a business to get paid for any marketing activity it might have produced but that have benefited another business, due to the automatic co-/cross-marketing of [MorphTransaction]s. Conversely, the [RedemptionTransaction] charges those businesses that have received the benefit of such [MorphTransaction]s. For businesses, all costs are strictly based on directly measurable results and performance. The cost of a [MarcomTransaction] follows from the delivery of a targeted marketing communication message. The cost of a [RedemptionTransaction] follows from the redemption of a promotional value (and hence a tangible sale for the business). The indirect (and future) cost of a [MorphTransaction] follows from receiving the benefit of having one owns promotional values delivered to a consumer, due to the marketing activities of another business. Conversely, for that business there is a compensation for such marketing activities that have benefited others.

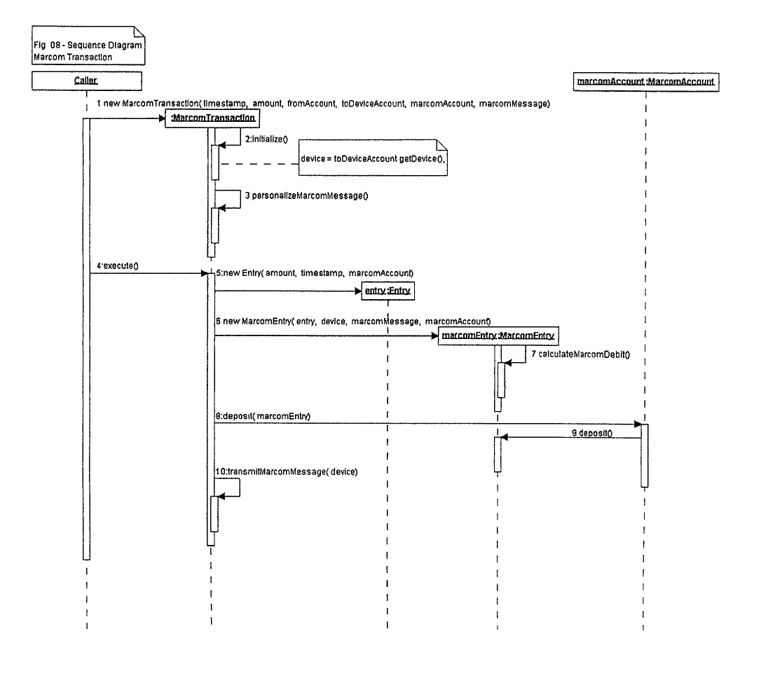

Description of FIG. 08—[MarcomTransaction] Execution

FIG. 08 is a sequence diagram that reveals what happens when a [MarcomTransaction] is executed. In Step 1 the system creates the [MarcomTransaction].

Here, and in subsequent sequence diagrams, the “system” is generically indicated as the [Caller]; in particular the caller will be the transaction manager of the system (the details of which are uninteresting for the purpose of describing the present invention).

The system will thus create a [MarcomTransaction]. In particular it will communicate to the [MarcomTransaction]: the [::timestamp] when the transaction is enacted, the [::amount] of points subject to the transaction, the [::marcomAccount] to which marketing communication charges should be charged, and the message [::marcomMessage] to be advertised. (Note that two additional parameters are given to the [MarcomTransaction]'s constructor: [::fromAccount] and [::toDeviceAccount]; their use will become clear with the subsequent description of the [AwardTransaction] and the [TransferTransaction]).

Step 2 occurs during the construction phase of the [MarcomTransaction]: it is a self call to the [MarcomTransaction::initialize( )] operation in order to assign values to any helper private member variables. In particular, the [MarcomTransaction::device] variable is assigned the value that is retrieved via a call to the [DeviceAccount:: getDevice( )] getter operation of the [::toDeviceAccount] parameter.

Step 3 also occurs during the construction phase of the [MarcomTransaction]: it is a self call to the [MarcomTransaction::personalizeMarcomMessage] operation. While the marketing communication message was specified as one of the original parameters, one of the key features of the [MarcomTransaction] is its capability to personalize that message before it is transmitted to the intended target consumer's [Device].

The degree of personalization can be as extreme as to totally replace the original message. However, how this adaptation of the marketing message actually happens does not form part of the invention as such. What is important, is the data that the invention makes available in order to perform such adaptation. In particular, the operation can base the adaptation on the following information:

1) The current amount of points delivered to the consumer's device: this can be considered as a direct measure of the consumer's interest level.

2) The moment in time of this delivery, and thereby apply seasonal or other time-based variations.

3) The recency and frequency of earlier marketing communications, which can be inferred from the time-ordered entries relating to the same target device and which are stored in the business's corresponding [MarcomAccount].

4) The recency, frequency and volume of earlier consumer activity regarding the same kind of [Point]s.

5) The speed of acquisition of such [Point]s.

6) The recency, frequency and volume of redemptions of that kind of [Point]s by that [Device], which are actually measurements of previous purchases.

This very capability of modifying the marketing communication message is an important feature of the invention. It is precisely due to this capability that it becomes feasible to compose marketing communication messages in an extremely targeted manner, and with a variety of strategies.

Once the system has created the [MarcomTransaction] and personalized the marketing communication message based on the above data, in Step 4 it will ask the [MarcomTransaction] to execute.

In Step 5, the [MarcomTransaction] start's its execution by creating an [Entry]. The new [Entry] is given the original [::timestamp] and [::amount]; and in particular it is associated with the [::marcomAccount]. Since the purpose of a [MarcomTransaction] is that of creating an entry in the [::marcomAccount], in Step 6 the [MarcomTransaction] creates a new [MarcomEntry] decorator. The [MarcomEntry] decorator is associated with the [Entry] created in Step 5, and with the [Device] retrieved in Step 2. Finally the actual [::marcommessage] and the associated [::marcomaccount] are specified.

Step 7 occurs during the construction phase of the [MarcomEntry]. Step 7 is a self-call to the [MarcomEntry:: calculateMarcomDebit( )] operation. This operation has the purpose of calculating the monetary value to be assigned to the [MarcomEntry::marcomDebit] attribute.

The actual mechanics of this computation are not described in detail. What is important is the kind of data that the invention makes available, and which can be used in order to perform this calculation. This is the same data that was available in Step 3 for personalizing the original marketing communication message. In other words, the marketing communication personalization effort will be billed to the business.

In Step 8 of the [MarcomTransaction]'s execution, the newly created [MarcomEntry] is deposited to the [::marcomAccount]; this registers the [MarcomEntry] into the time ordered collection of [MarcomEntry]'s kept by the [MarcomAccount]. Notice also that in Step 9 the [MarcomAccount] will call the corresponding [MarcomEntry::deposit( )] operation, ensuring that the entry's amount is given the appropriate sign and stored to persistent storage. (As stated earlier, this is common pattern with any invocations of the [Account::deposito] and the [Account::withdraw( )] operations: they will always invoke the homonymous operation on their [Entry] parameter.) Finally, Step 10 is a self-call to the [MarcomTransaction::transmitMarcomMessage( )] operation that will transmit the marketing communication message to the intended target consumer's [Device].

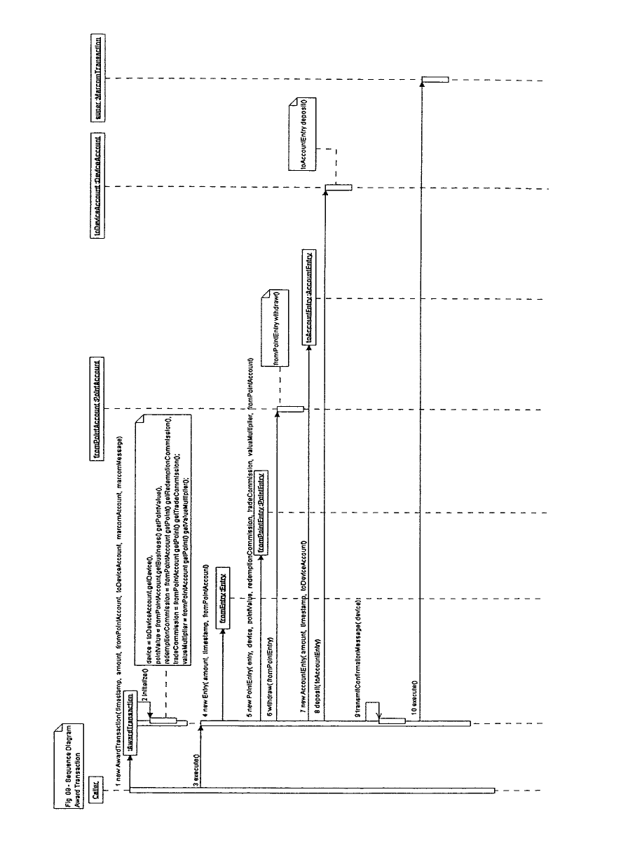

Description of FIG. 09—[AwardTransaction] Execution

FIG. 09 is a sequence diagram that uncovers what happens when an [AwardTransaction] is executed. In Step 1 the system creates the [AwardTransaction]. It is important to recall that an [AwardTransaction] is a [MarcomTransaction] too, and hence it inherits all features of the [MarcomTransaction]. Therefore the system will pass to the [AwardTransaction]'s constructor the same information that is needed to build a [MarcomTransaction]. In particular, though, the [AwardTransaction] differs from the [MarcomTransaction] because the [::fromAccount] parameter is expected to be of the more specific class [PointAccount] rather than the more generic class [Account]. Accordingly the system will build the constructor parameters list in order to include a specific [::fromPointAccount].

Step 2 occurs during the construction phase of the [AwardTransaction]: it is a self call to the [AwardTransaction:: initialize( )] operation in order to assign values to any helper private member variables. As indicated by the note in the diagram, helper variables exist to represent the target [Device], the [Business::pointValue], the [Point:: redemptioncommission], the [Point::tradeCommission] and the [Point::valueMultiplier]. The values assigned to said private instance variables are retrieved, directly or indirectly from the [::toDeviceAccount] and [::fromPointAccount] constructor parameters.

In Step 3 the system asks the [AwardTransaction] to execute. The purpose of an [AwardTransaction] is to transfer ownership of an amount of [Point]s from a [Business] to a consumer's [Device]; more specifically from the [Business]'s corresponding [PointAccount] to the [Device]'s corresponding [DeviceAccount]. Therefore the [AwardTransaction] needs to create, withdraw and deposit new [Entry]'s in the two accounts.

In Step 4 the [AwardTransaction] creates a base [Entry] for the originating [::fromPointAccount]. This [Entry] needs to be decorated with information that is specific to [PointAccount]s. In Step 5 the [AwardTransaction] creates a new [PointEntry] decorator. The [PointEntry] decorator is associated with the [Entry] created in Step 4. The [PointEntry] is also associated with the [Device] to which the [Point]s are awarded. Also the other pieces of information retrieved in Step 2 are passed to the [PointEntry]'s constructor (i.e. the pointvalue, redemptionCommission, tradeCommission and valueMultiplier).

In Step 6 the newly created [PointEntry] is withdrawn from the [::fromPointAccount].

In Step 7 a new [AccountEntry] is created and associated with the [::toDeviceAccount]; and in Step 8 the newly created [AccountEntry] is deposited to the [::toDeviceAccount]. (As the two notes remind us, the withdraw and deposit operations in Step 6 and Step 8 will invoke the homonymous operation on their [Entry] parameter.)

When all accounts have been updated, in Step 9 the [AwardTransaction] will take care of transmitting a confirmation message to the target [Device]. Then the ancestor's [MarcomTransaction::execute( )] operation is invoked as Step 10. In other words, this means that Step 10 of FIG. 09, corresponds to Step 4 of FIG. 08.

It is by virtue of this behavior that an important advantage of the present invention is realized: a marketing communication message is being delivered contextually with the delivery of a tangible promotional value. (The consumer has just received an amount of M-Points immediately prior to being presented with the marketing communication message.)

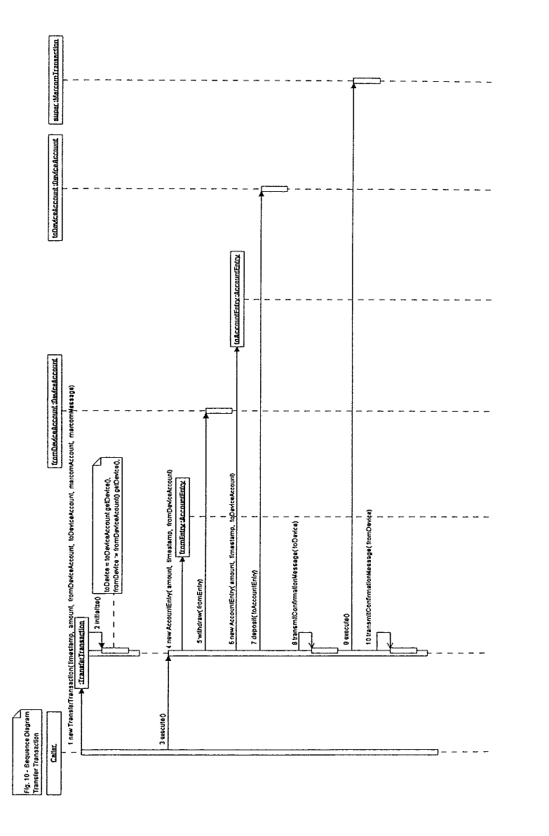

Description of FIG. 10—[TransferTransaction] Execution

FIG. 10 is a sequence diagram that shows what happens when a [TransferTransaction] is executed. In Step 1 the system creates the [TransferTransaction]. It is important to recall that an [TransferTransaction] is a [MarcomTransaction] too, and hence it inherits all features of the [MarcomTransaction]. Therefore the system will pass to the [TransferTransaction]'s constructor the same information that is needed to build a [MarcomTransaction]. In particular, though, the [TransferTransaction] differs from the [MarcomTransaction] because the [::fromAccount] parameter is expected to be of the more specific class [DeviceAccount] rather than the more generic class [Account]. Accordingly the system will build the constructor parameters list in order to include a specific [::fromDeviceAccount].

Step 2 occurs during the construction phase of the [TransferTransaction]: it is a self call to the [TransferTransaction::initialize( )] operation in order to assign values to any helper private member variables. As indicated by the note in the diagram, helper variables exist to represent the source and the target [Device]s.

In Step 3 the system asks the [TransferTransaction] to execute.

The purpose of an [TransferTransaction] is to transfer ownership of an amount of [Point]s from one consumer's [Device] to another consumer's [Device]; more specifically from the first [Device]'s corresponding [DeviceAccount] to the second [Device]'s corresponding [DeviceAccount]. Therefore the [TransferTransaction] needs to create, withdraw and deposit new [AccountEntry]'s in the two accounts.

In Step 4 the [TransferTransaction] creates an [AccountEntry] and associates it with the originating [::fromDeviceAccount]. In Step 5 the newly created [AccountEntry] is withdrawn from the [::fromDeviceAccount].

In Step 6 the [TransferTransaction] creates an [AccountEntry] and associates it with the target [::toDeviceAccount]In Step 7 the newly created [AccountEntry] is deposited to the [::toDeviceAccount]. (As usual, albeit not shown in the diagram, the withdraw and deposit operations in Step 5 and Step 7 will invoke the homonymous operation on their [Entry] parameter.)

In Step 8 the [TransferTransaction] takes care of informing the target [Device] about the new [Point]s that have been credited. Then the ancestor's [MarcomTransaction:: execute( )] operation is invoked as Step 9. In other words, this means that Step 9 of FIG. 10, corresponds to Step 4 of FIG. 08.

Finally in Step 10 a confirmation message is also sent to the source [Device] with a statement about the [Point]s that have been withdrawn.

Like the case of the [AwardTransaction], the [TransferTransaction] realizes an important benefit of the present invention: a marketing communication message is being delivered contextually with the delivery of a tangible promotional value. (The consumer has just received an amount of M-Points immediately prior to being presented with the marketing communication message.)

Furthermore, the [TransferTransaction] leverages the marketing communication vehicle by taking advantage of the transfer of [Point] ownership from consumer to consumer. In other words, the [Business] whose marketing communication is being delivered via a [TransferTransaction] has not had to sustain any kind of upfront marketing expenditure. Any marketing communication message delivered via a [TransferTransaction] takes indirect advantage of the knowledge that consumers have about each others. If one consumer transfers some M-Point's to another, it can be inferred that the first consumer has reason to believe that the second one will appreciate receiving those M-Points. This is valuable knowledge that ordinarily is not available to the [Business], which nonetheless is now enabled to perform marketing communication by targeting the message through said indirect and inferred know how.

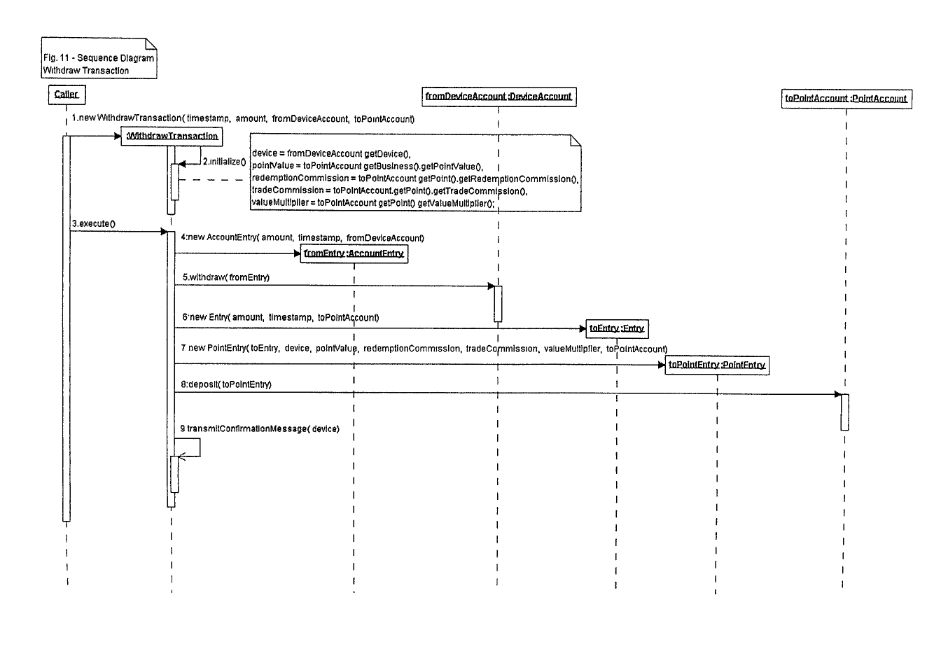

Description of FIG. 11—[WithdrawTransaction] Execution

FIG. 11 is a sequence diagram that shows what happens when a [WithdrawTransaction] is executed. In Step 1 the system creates the [WithdrawTransaction].

Step 2 occurs during the construction phase of the [WithdrawTransaction]: it is a self call to the [WithdrawTransaction::initialize( )] operation in order to assign values to any helper private member variables. As indicated by the note in the diagram, helper variables exist to represent the source [Device], the [Business::pointValue], the [Point::redemptionCommission], the [Point::tradeCommission] and the [Point::valueMultiplier]. The values assigned to said private instance variables are retrieved, directly or indirectly from the [::fromDeviceAccount] and [::toPointAccount] constructor parameters.

In Step 3 the system asks the [WithdrawTransaction] to execute. The purpose of a [WithdrawTransaction] is to transfer ownership of an amount of [Point]s from a consumer's [Device] to a [Business]; more specifically from the [Device]'s corresponding [DeviceAccount] to the [Business]'s corresponding [PointAccount]. Therefore the [WithdrawTransaction] needs to create, withdraw and deposit new [Entry]'s in the two accounts.

In Step 4 the [WithdrawTransaction] creates an [AccountEntry] for the originating [::fromDeviceAccount]; and in Step 5 the newly created [AccountEntry] is withdrawn from the [::fromDeviceAccount].

In Step 6 the [WithdrawTransaction] creates a base [Entry] for the target [::toPointAccount]. The [Entry] needs to be decorated with information that is specific to [PointAccount]s. In Step 7 the [WithdrawTransaction] creates a new [PointEntry] decorator. The [PointEntry] decorator is associated with the [Entry] created in Step 6. The [PointEntry] is also associated with the [Device] from which the [Point]s are taken. Also the other pieces of information retrieved in Step 2 are passed to the [PointEntry]'s constructor (i.e. the pointvalue, redemptionCommission, tradecommission and valueMultiplier). In Step 8 the newly created [PointEntry] is deposited to the [::toPointEntry]. (As usual, albeit not shown in the diagram, the withdraw and deposit operations in Step 5 and Step 8 will invoke the homonymous operation on their [Entry] parameter.)

Finally in Step 9 the [WithdrawTransaction] will transmit a confirmation message to the source [Device], confirming that an amount of [Point]s have been withdrawn from the corresponding [DeviceAccount].

In previous point loyalty system, the act of redeeming points was (naturally) contemplated. One fundamental improvement introduced by the invention is distinguishing the act of transferring point ownership back from a consumer to the original issuing business, from the act of redeeming the points. This distinction allows to turn the [WithdrawTransaction] into a building block for both the [RedemptionTransaction] proper, but also (and more importantly) for the [MorphTransaction]. Since the [MorphTransaction] plays a crucial role in enabling the virtual marketplace of promotional values between businesses, and materially permits businesses to automatically and continuously take advantage of co-/cross-marketing efforts, it follows that the [WithdrawTransaction] is also an enabler of said virtual marketplace of promotional values.

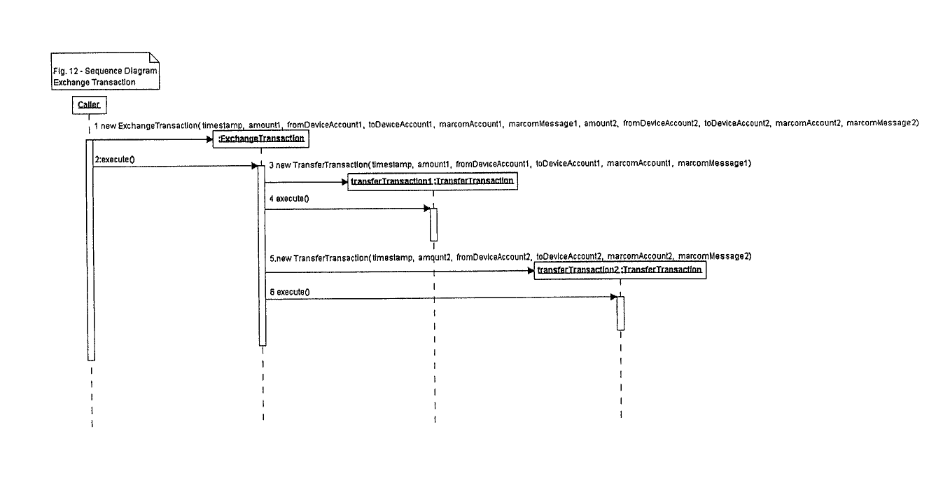

Description of FIG. 12—[ExchangeTransaction] Execution

FIG. 12 is a sequence diagram that illustrates what happens when an [ExchangeTransaction] is executed. In Step 1 the system creates the [ExchangeTransaction]. In Step 2 the system asks the [ExchangeTransaction] to execute.

An [ExchangeTransaction] is basically the composition of two distinct [TransferTransaction]s: therefore its execution is straightforward. In Step 3 the [ExchangeTransaction] creates the first [TransferTransaction] and in Step 4 it is executed. In Step 5 the [ExchangeTransaction] creates the second [TransferTransaction], and in Step 6 it is executed.

Since the two [TransferTransaction]s are also [MarcomTransaction]s, the whole [ExchangeTransaction] causes two marketing communication messages to be delivered. The same considerations done for the [TransferTransaction] apply (doubly) to the [ExchangeTransaction]. In other words, the [Business]es whose marketing communication messages are delivered to the two consumers involved in the [ExchangeTransaction] can do so in a highly targeted manner, by taking advantage of the consumer's reciprocal knowledge about the other consumer's interest in certain [Point]s.

Description of FIG. 13—[MorphTransaction] Execution

FIG. 13 is a sequence diagram that shows what happens when a [MorphTransaction] is executed. In Step 1 the system creates a [MorphTransaction].

Step 2 occurs during the construction phase of the [MorphTransaction]: it is a self call to the [MorphTransaction:: initialize( )] operation in order to assign values to any helper private member variables. As indicated by the note in the diagram, helper variables exist to represent the source and target [Device]s; the source and target [Point::valueMultiplier]s; and the source and target [Point::tradeCommission]s. The values assigned to said private instance variables are retrieved, directly or indirectly from the [::fromDeviceAccount], [::toDeviceAccount], [::sourcePointAccount], and [::targetPointAccount] constructor parameters.

Step 3 also occurs during the construction phase. It is a call to the [MorphTransaction::calculateBuyAmount( )] operation, and its result is assigned to the [::buyAmount] helper variable. It is by virtue of this operation that an amount of [Point]s issued by one [Business] can be transformed into a different amount of [Point]s of another [Business]. In particular, the expression: (buyAmount =(fromValueMultiplier*(fromAmount−fromAmount*from-TradeCommission( )/100))/toValueMultiplier) encloses all the logic underlying such transformation. It can be seen that the original amount of [Point]s is reduced by the source [Point::tradeCommission], and the result is then corrected according to the conversion factor given by the ratio between the source and target [Point::valueMultiplier]s. Moreover, since fractional points will not be handled (mainly due to terms of service), if the computed result is non-integer, then it will be floored (i.e. rounded towards zero) to the nearest non-negative integer (although this step is not explicitly shown on the diagram).

In Step 4 the system asks the [MorphTransaction] to execute. The [MorphTransaction] will create (Step 5) and execute (Step 6) a [WithdrawTransaction] for the original [::amount] of [Point]s. Then it will create (Step 7) and execute (Step 8) an [AwardTransaction], but this time for the [::buyAmount] of [Point]s calculated in Step 3.

For bookkeeping purposes, the [MorphTransaction] then needs to create two [Entry]s in the [::fromMorphAccount] and in the [::toMorphAccount]. An ordinary [Entry] for the original [::amount] is created in Step 9, and associated with the [::fromMorphAccount]. In Step 10, that same entry is decorated with a new [MorphEntry] decorator. In Step 11 the newly created [MorphEntry] is withdrawn from the [::fromMorphAccount]. Then An ordinary [Entry] for the calculated [::buyAmount] is created in Step 12, and associated with the [::toMorphAccount]. In Step 13, that same entry is decorated with a new [MorphEntry] decorator. In Step 14 the newly created [MorphEntry] is deposited to the [::toMorphAccount]. (As usual, albeit not shown in the diagram, the withdraw and deposit operations in Step 11 and Step 14 will invoke the homonymous operation on their [Entry] parameter.)

It is by virtue of the [MorphEntry::calculateBuyAmount( )] calculation that a [MorphEntry] enables automatic and ongoing co-/cross-marketing activities between businesses, despite the fact that there exists no direct relationships between the businesses. All operations are mediated by the service provider. All debits/credits due/accrued for any [MorphTransaction] executed by a consumer are transformed into future increase/decrease of the nominal redemption commissions. Therefore any direct billing for a trade transaction is avoided.

Description of FIG. 14—[RedemptionTransaction] Execution

FIG. 14 is a sequence diagram that shows what happens when a [RedemptionTransaction] is executed. In Step 1 the system creates the [RedemptionTransaction]. Step 2 occurs during the construction phase of the [RedemptionTransaction]: it is a self call to the [RedemptionTransaction::initialize( )] operation in order to assign values to any helper private member variables. As indicated by the note in the diagram, helper variables exist to represent the originating [Device], the [Business:: pointvalue], the [Point::redemptionCommission], and the [Point::valueMultiplier]. The values assigned to said private instance variables are retrieved, directly or indirectly from the [::fromDeviceAccount] and [::toPointAccount] constructor parameters.

In Step 3 the system asks the [RedemptionTransaction] to execute. The purpose of a [RedemptionTransaction] is to transfer ownership of an amount of [Point]s back from a consumer's [Device] to a [Business]; more specifically from the [Device]'s corresponding [DeviceAccount] to the [Business]'s corresponding [PointAccount]. This is exactly what a [WithdrawTransaction] is capable of performing. Therefore, in Step 4, the [RedemptionTransaction] creates a new [WithdrawTransaction] passing in the appropriate parameters, and then asks it to execute in Step 5.

A [RedemptionTransaction] must also perform bookkeeping associated with a point redemption, and in particular compute the debit to be billed to the [Business] involved. To this end, the [RedemptionTransaction] needs to create and deposit an [Entry] in a [RedeemAccount].

In Step 6 the [RedemptionTransaction] creates a new [Entry] for the associated [RedeemAccount]. The [Entry] needs to be decorated with information that is specific to redemptions. In Step 7 the [RedemptionTransaction] creates a new [RedeemEntry] decorator. The [RedeemEntry] decorator is associated with the [Device] from which the [Point]s are taken. Also the other pieces of information retrieved in Step 2 are passed to the [RedeemEntry]'s constructor (i.e. the pointvalue, redemptionCommission, and valueMultiplier). Finally the [RedeemEntry] is also associated with the appropriate [RedeemAccount].

Step 8 occurs during the construction phase of the [RedeemEntry] decorator: it is a self call to the [RedeemEntry:: calculateRedeemDebit( )] operation. (The calculation performed in Step 8 is the most complex part of the transactional engine, and is fully described by FIG. 15.)

In Step 9, the newly created [RedeemEntry] is deposited to the [::redeemAccount]. (As usual, albeit not shown in the diagram, the withdraw operation will invoke the homonymous operation on the [Entry] parameter.)

It is by virtue of the [RedeemEntry::calculateRedeemDebit( )] operation that redemptions are debited to businesses, all the while any appropriate adjustments due to pending retroactive (morph) trade commissions are applied.

Description of FIG. 15—Redeem Debit Calculation

FIG. 15 is a sequence diagram that expounds how the calculation referenced in Step 8 of FIG. 14 is performed. Step 1 occurs during the construction phase of a [RedeemEntry] decorator: the [RedeemEntry] will make a self call to the [RedeemEntry::calculateRedeemDebit( )] operation. The calculation involves both iterations and conditional execution paths; therefore the following description will be broken down according to various conditions and scenarios that might arise.

In Step 2 the [RedeemEntry] will invoke the [RedeemAccount::createCommissionsFor(aRedeemEntry)] operation. In other words, the new [RedeemEntry] is delegating the chore of the work to its corresponding [RedeemAccount]. Notice that the [RedeemEntry] will pass itself to the [RedeemAccount] as the parameter of the [RedeemAccount::createCommissionsFor( )] operation. In this way, the [RedeemAccount] will be knowledgeable about the [RedeemEntry] that initiated the operation, and can further cooperate with it.

In Step 3 the [RedeemAccount] sets the private helper variable [::amountToBeRedeemed] to be equal to the total amount of [Point]s to be redeemed. This value is retrieved, naturally, via an invocation to the [RedeemEntry:: getAmount( )] getter operation, applied to the [::aRedeemEntry] reference.

In Step 4 an iteration is begun over all applicable morph-adjustments (i.e. morph transaction entries that have not yet been debited or credited), and as long as there are still [Point]s to be redeemed. The iteration is controlled by the expression: (amountToBeRedeemed>0) && MorphAccount::hasMorphAdjustment ( ).

As the diagram shows, the control expression of the iteration includes an invocation to the [MorphAccount::hasMorphAdjustment( )] operation. The invocation is applied to the [RedeemAccount::morphAccount] private attribute, which associates each [RedeemAccount] to its corresponding [MorphAccount].

We will examine what happens during the [MorphAccount::hasMorphAdjustment( )] shortly. For now, lets assume that the operation returns with False. This means that there have never been any [MorphTransaction]s for the kind of [Point] subject to the redemption (or more precisely, there are no outstanding [MorphTransaction] debits/credits adjustments that need to be accounted for).

Naturally the first time through the iteration, [::amountToBeRedeemed] is certainly greater than zero (or else execution would never have reached this point). So, if there are [Point]s to be redeemed, but no morph adjustments to be applied, the overall result of the iteration control expression will be False; and the iteration body will be skipped altogether. This would bring us directly from Step 4 to Step 22, which is the conditional execution path (the other one being Step 21) taken when [::amountToBeRedeemed] is greater than zero. In Step 22, the [RedeemAccount] will call back into the originating [RedeemEntry] and invoke the [RedeemEntry::addRedeemCommission( )] operation. Notice that the first parameter of the operation is [::amountToBeRedeemed]. At this point (since there were no morph adjustments applied), [::amountToBeRedeemed] corresponds to the original total amount of [Point]s being redeemed. Also notice that the second parameter to the operation (corresponding to the trade commission) is set to zero. Again this is because there are no morph adjustments to be accounted for (i.e. there is no retroactive trade commission). In Step 23 the [RedeemEntry] will create a new [RedeemCommission], associating it with itself, and for the given amount of points, with a zero trade commission. As indicated by the note, in the newly created [RedeemCommission] the [RedeemCommission::redemptionValue] attribute will be set to the expression: (amount*redeemEntry.getPointValue( )* redeemEntry.getValueMultiplier( )); and finally the [RedeemCommission::redemptionDebit] attribute can be calculated via the expression: (redemptionvalue*redeemEntry.getRedemptionCommission( )* (100+tradeCommission)/10000). In this particular case, since the trade commission is zero, the nominal redemption commission will be applied unchanged.

In Step 24 execution returns to the [RedeemAccount]; then, in Step 25, back to the originating [RedeemEntry], by which point the whole operation is done.

Now, back to Step 4. We will now examine the more complex scenario when there are indeed pending morph adjustments to be applied. Lets see what happens at the beginning of the iteration. The [::amountToBeRedeemed] helper variable is positive, as in the preceding scenario. In Step 4 the [MorphAccount::hasMorphAdjustment( )] operation is invoked as part of the iteration control expression. The [MorphAccount] has two private attributes that are involved in the operation: first is the [MorphAccount::amountAvailableForAdjustment] attribute, and second is [MorphAccount::currentAdjustmentMorphEntry] attribute which is a reference to a [MorphEntry]. If this is the first time ever a [RedemptionTransaction] happens (and, as per hypothesis, there have been earlier [MorphTransaction]s for the same kind of [Point] s), then [MorphAccount::amountAvailableForAdjustment] will initially be zero, and [MorphAccount::currentAdjustmentMorphEntry] will be unassigned.

In Step 5, the result of the [MorphAccount::hasMorphAdjustment( )] operation is set to the result of the boolean expression (amountAvailableForAdjustment >0). If this is true, the operation will return immediately via Step 6. However, since in our scenario, this is the first time ever the operation takes place, this will not be the case, and execution proceeds with Step 7.

In Step 7 the [MorphAccount::currentAdjustmentMorphEntry] attribute is set via a self call to the [MorphAccount::getNextAdjustmentMorphEntry( )]. Since this is the very first time the operation is invoked, it will return the (chronologically) very first [MorphEntry] associated with the [MorphAccount]. On subsequent invocations, [MorphAccount::getNextAdjustmentMorphEntry( )] will return the [MorphEntry] that comes, chronologically, immediately after the [MorphEntry] referenced by the [MorphAccount::currentAdjustmentMorphEntry] attribute. Eventually the situation might arise where the [MorphAccount::currentAdjustmentMorphEntry] references the (chronologically) very last [MorphEntry] that is associated with the [MorphAccount]. In this case the [MorphAccount::getNextAdjustmentMorphEntry( )] will return with a nil. If this were the case then the [MorphAccount::hasMorphAdjustment( )] operation would return with a value of False, as indicated by Step 8.

However, under the hypothesis that this is the very first time through, and that there are indeed one or more [MorphEntry]s to be examined, the [MorphAccount::currentAdjustmentMorphEntry] will now references the (chronologically) very first [MorphEntry] that is associated with the [MorphAccount]. Therefore, in Step 9, the [MorphAccount::amountAvailableForAdjustment] attribute can be set via an invocation to the [MorphEntry::getAmount( )] getter operation applied to the [MorphEntry] just assigned to the [MorphAccount::currentAdjustmentMorphEntry] attribute. Notice that the amount returned by [MorphEntry:: getAmount( )] is taken in absolute value. This is because the [MorphEntry::amount] attribute can be negative (specifically, in those cases where the original [MorphTransaction] caused the [Business] to relinquish [Point] rather than gaining them). Notice also that the correct sign (i.e. plus or minus) will nonetheless be accounted for by the [MorphEntry::tradecommission] that will be used in Step 17 and Step 23.

Finally in Step 10 the operation returns with True (because a valid [MorphEntry] has now been found and there exists an [::amountAvailableForAdjustment]).

In Step 11, the [::redeemCommissionAmount] helper variable is set to the minimum value between the original [::amountToBeRedeemed] helper variable and the value returned by the invocation of the [MorphAccount::getAmountAvailableForAdjustment( )] operation applied on the [RedeemAccount::morphAccount] reference. Naturally, under the stated hypothesis, this last invocation will return the amount retrieved in Step 9. The reason why the minimum value is take is this: obviously you cannot redeem more [Point]s than those that were initially requested. So if the amount to be redeemed is less than the amount available for adjustment we need to operate with the former. On the other hand if the converse is true, i.e. the amount to be redeemed is greater than the amount available for adjustment, we can apply the retroactive trade commission only for the amount available for adjustment (and then deal with the remaining non-redeemed points the next time through the iteration).

In Step 12 the [::redeemTradeCommission] helper variable is set via a call to the [MorphAccount::getTradeCommission( )] operation applied to the [RedeemAccount::morphAccount] private attribute. This in turn will, in Step 13, retrieve the trade commission via the [MorphEntry::getTradeCommission( )] getter operation applied to the [MorphAccount::currentAdjustmentMorphEntry] reference. In other words, the trade commission of the current adjustment morph entry is retrieved. Via Step 14 and Step 15 the said trade commission is returned to the [RedeemAccount::redeemTradeCommission] helper variable.

In Step 16, the [RedeemAccount] will call back into the originating [RedeemEntry] and invoke the [RedeemEntry:: addRedeemCommission( )] operation. Notice that the first parameter of the operation is the [::redeemCommissionAmount] helper variable that was set in Step 11, while the second parameter is the [::redeemTradeCommission] helper variable set in Step 12.

In Step 17 the [RedeemEntry] will create a new [RedeemCommission], associating it with itself. As indicated by the note, in the newly created [RedeemCommission] the [RedeemCommission::redemptionValue] attribute will be set to the expression: (amount*redeemEntry.getPointValue( )* redeemEntry.getValueMultiplier( )); and finally the [RedeemCommission::redemptionDebit] attribute can be calculated via the expression: (redemptionvalue * redeemEntry.getRedemptionCommission( )*(100+tradeCommission)/10000). Notice that in this case the trade commission will be a non zero value, and it can be positive or negative, respectively, depending on the fact that it represents a retroactive debit or credit (to the business) for the corresponding (partial or whole) morph transaction that is being rolled over to the newly created [RedeemCommission].

In Step 18 execution returns back to the [RedeemAccount] In Step 19 the [::amountToBeRedeemed] helper variable is updated, and assigned the difference between itself and the [::redeemCommissionAmount], which was computed in Step 11 (notice that this affects the iteration control expression the next time it is tested!). In Step 20 the [MorphAccount: amountAvailableForAdjustment] is updated and decremented by the [::redeemCommissionAmount] too. At this point execution returns back to Step 4, for another round through the iteration.

Although we will not describe all remaining possible execution paths, it should be clear from the diagram how the various scenarios are handled, especially when the original [::amountToBeRedeemed] is so large that it needs to be broken down into a multitude of [RedeemCommission]s by multiple repetitions of the iteration starting at Step 4. It should be clear how the retroactive trade commissions are distributed to the appropriate amount of points assigned to the single [RedeemCommission]s. It should also be evident how the [MorphAccount::amountAvailableForAdjustment] and the [MorphAccount::currentAdjustmentMorphEntry] attributes keep track of which [MorphEntry] have yet to be considered, and how much of the corresponding amount is still available. And finally, if the iteration starting at Step 4 ends and there are still [Point] s to be handled, they will create a final [RedeemCommission] (via Steps 22 and 23).

Example of Account Flows

We will now show, by means of a concrete example, how the above system would handle some typical transactions and reflect their outcome in the corresponding accounts and account entries. Lets assume we have two businesses, indicated by the fictitious names of K-Food and Z-Drink; and two consumers, Joe and Ann. The scenario will cover ordinary brand K-Food points and promotional points from Z-Drink; say the promotion is called Z-Promo and that the scenario unravels during the promotional period. We also assume that K-Food has a trade commission of 10%, while Z-Drink has a trade commission of 50%. Furthermore, we assume that Z-Drink has a value multiplier of 2. (Naturally, the value multiplier for K-Food is 1, since we are dealing with ordinary brand points). We will assume that K-food's brand point has a redemption commission of 4%, while Z-Drink's promo point has a redemption commission of 10% (promotions cost more). Finally, in order to simplify computation, we will assume that both businesses will have a point value of 1$. (Note that all of these figures are unrealistic: they have been chosen in order to make the description easier to follow and understand.)

The scenario is summarized by the following table:

| Time | Event |
|---|---|
| T1 | K-Food awards 100 brand points to Joe. |
| T2 | Z-Drink awards 50 Z-Promo points to Ann. |
| T3 | Joe redeems 20 K-Food brand points. |
| T4 | Joe donates 30 K-Food brand points to Ann. |
| T5 | Joe exchanges 20 K-Food brand points for |
| | 30 Z-Promo points with Ann. |
| T6 | Joe morphs 20 K-Food brand points into Z- |
| | Promo points. |
| T7 | Joe redeems 20 Z-Promo points. |
| T8 | Ann redeems 30 K-Food brand points. |

Let's examine each of these phases.

T1—K-Food Awards 100 Brand Points to Joe.

At time T1 K-Food awards 100 brand points to Joe. After the [AwardTransaction], Joe's [DeviceAccount]'s will look like this:

Joe's Points

| Time | K-Brand | Z-Promo |
|---|---|---|
| T1 | +100 | |
| Balance | +100 | 0 |

K-Food's [BusinessAccount]'s will look like this

K-Food's Brand Points

| Time | Point | Marcom | Morph | Redeem |
|---|---|---|---|---|
| T1 | −100 | +100 | | |
| Balance | −100 | +100 | 0 | 0 |

There are two things to notice. First that K-Food's [PointAccount] is debited, while Joe's [DeviceAccount] is credited: this is like ordinary double entry bookkeeping. Second, since an [AwardTransaction] is also [MarcomTransaction], K-Food will have had the opportunity to present a marketing communication message to Joe. The fact is being recorded by a positive entry in K-Food's [MarcomAccount] it is representative of the marketing communication benefit that K-Food has received.

T2—Z-Drink Awards 50 Z-Promo Points to Ann.

At time T2 Z-Drink awards 50 Z-Promo points to Ann. After the operation, Ann's [DeviceAccount]s will look like this:

Ann's Points

| Time | K-Brand | Z-Promo |
|---|---|---|
| T2 | | +50 |
| Balance | 0 | +50 |

While Z-Drink's [BusinessAccount]s will look like this:

Z-Drink's Promo Points

| Time | Point | Marcom | Morph | Redeem |
|---|---|---|---|---|
| T2 | −50 | +50 | | |
| Balance | −50 | 50 | 0 | 0 |

Even in this case, notice that the [MarcomAccount] is being credited, because of the implied marketing communication activity.

T3—Joe Redeems 20 K-Food Brand Points.

At time T3 Joe redeems 20 of his K-Food brand points. Now his [DeviceAccount]'s look like this:

Joe's Points

| Time | K-Brand | Z-Promo |
|---|---|---|
| T1 | +100 | |
| T3 | −20 | |
| Balance | +80 | 0 |

K-Food's [BusinessAccount]'s look like this:

K-Food's Brand Points

| Time | Point | Marcom | Morph | Redeem |
|---|---|---|---|---|
| T1 | −100 | +100 | | |
| T3 | +20 | | | +20 |
| Balance | −80 | 100 | 0 | +20 |

Notice that the [RedemptionTransaction] has created an entry in K-Food's [RedeemAccount]. Corresponding to that entry, there will also be a new [RedeemCommission]. Since there has not been any morphing activity by Joe involving K-Food's [BrandPoint], that will be the only [RedeemCommission] created. It's [RedeemCommission::redemptionValue] attribute is calculated as the (absolute value of the) amount of points (+20) multiplied by the point value (+1$) multiplied by the value multiplier (1). In other words, the redemption value is +20$. The corresponding [RedeemCommission:redemptionDebit] is calculated as the redemption commission (4%) of the redemption value (+20$). In other words, the redemption debit will be+0.80$. Notice that there is no retroactive trade commission to be applied in this case. We can illustrate the redeem commission with the following table:

K-Food's Redeem Commissions

| Time | Commission # | Redemption Debit |
|---|---|---|
| T3 | 1 | 0.80 |

T4—Joe Donates 30 K-Food Brand Points to Ann.

At time T4 Joe donates 30 K-Food brand points to Ann. Naturally his K-Food [DeviceAccount] will be debited:

Joe's Points

| Time | K-Brand | Z-Promo |
|---|---|---|
| T1 | +100 | |
| T3 | −20 | |
| T4 | −30 | |
| Balance | +50 | 0 |

While the Ann's K-Food [DeviceAccount] will be credited:

Ann's Points

| Time | K-Brand | Z-Promo |
|---|---|---|
| T2 | | +50 |
| T4 | +30 | |
| Balance | +30 | +50 |

Notice what happens with K-Food's [BusinessAccount]'s:

K-Food's Brand Points

| Time | Point | Marcom | Morph | Redeem |
|---|---|---|---|---|
| T1 | −100 | +100 | | |
| T3 | +20 | | | +20 |
| T4 | | +30 | | |
| Balance | −80 | +130 | 0 | +20 |

Since the donation involved a [TransferTransaction], which is also a [MarcomTransaction], K-Food has had the opportunity to present a marketing communication message (to Ann, of course). Therefore it's [MarcomAccount] is being credited accordingly. It is important to stress that K-Food received this opportunity not because of some direct marketing activity of its own, but because of the indirect intermediation of Joe. Joe, donating K-Food points to Ann, has some reason to believe that Ann appreciates those points: and that reason is unbeknownst to K-Food. Nonetheless, K-Food not only gets the (potential) benefit of having its points delivered to someone who is more likely to take advantage of the corresponding promotion, but also gets the (concrete) benefit of a marketing communication impression delivered to a person who is interested. The amount of points involved is also (indirectly) a measure of the person's interest level in the point's specific brand and/or promotion.

T5—Joe Exchanges 20 K-Food Brand Points for 30 Z-Promo Points with Ann.

At time T5, Joe exchanges 20 K-Food brand points for 30 Z-Promo points with Ann. This is what happens to Joe's [DeviceAccount]s:

Joe's Points

| Time | K-Brand | Z-Promo |
|---|---|---|
| T1 | +100 | |
| T3 | −20 | |
| T4 | −30 | |
| T5 | −20 | +30 |
| Balance | +30 | +30 |

And this is what happens to Ann's [DeviceAccount]s:

Ann's Points

| Time | K-Brand | Z-Promo |
|---|---|---|
| T2 | | +50 |
| T4 | +30 | |
| T5 | +20 | −30 |
| Balance | +50 | +20 |

Notice however that an [ExchangeTransaction] is composed of two [TransferTransaction], which are also [MarcomTransaction]s. Therefore there is the following activity on K-Food's [MarcomAccount]:

K-Food's Brand Points

| Time | Point | Marcom | Morph | Redeem |
|---|---|---|---|---|
| T1 | −100 | +100 | | |
| T2 | | | | |
| T3 | +20 | | | +20 |
| T4 | | +30 | | |
| T5 | | +20 | | |
| Balance | −80 | +150 | 0 | +20 |

Similarly for Z-Drink's [MarcomAccount] we have this:

Z-Drink's Promo Points

| Time | Point | Marcom | Morph | Redeem |
|---|---|---|---|---|
| T2 | −50 | +50 | | |
| T5 | | +30 | | |
| Balance | −50 | +80 | 0 | 0 |

Again, the same considerations apply, regarding businesses' opportunity to present marketing communication messages without having had to sustain any direct up front marketing activity, and exploiting the consumers' knowledge about each others.

T6—Joe Morphs 20 K-Food Brand Points into Z-Promo Points.

At time T6, Joe morphs 20 K-Food brand points into Z-Promo points. On the one hand a [MorphTransaction] composes a [WithdrawTransaction], while on the other hand it composes an [AwardTransaction]. The effect of the [WithdrawTransaction] results in K-Food's [PointAccount] being credited. The [MorphTransaction] as such will also debit K-Food's [MorphAccount]. Hence K-Food's [BusinessAccount]s evolve as follows:

K-Food's Brand Points

| Time | Point | Marcom | Morph | Redeem |
|---|---|---|---|---|
| T1 | −100 | +100 | | |
| T3 | +20 | | | +20 |
| T4 | | +30 | | |
| T5 | | +20 | | |
| T6 | +20 | | −20@−10% | |
| Balance | −60 | +150 | −20 | +20 |

Notice, in the above table, how the new entry in the [MorphAccount] highlights both the amount as well as the applicable trade commission. K-Food's trade commission is −10%, with a negative sign because K-Food is giving away points.

The effect of the [AwardTransaction] will be based on the calculated buy amount (as described in FIG. 13, Step 3). In this case the buy amount is computed like: K-Food's value multiplier (1) multiplied by the original amount of points (20) decreased by the original trade commission (10%), and all divided by Z-Drink's value multiplier (2). In other words: 1*(20-20*10/100)/2=9. In other word, Joe's original 20 K-Food brand points will be converted into 9 Z-Drink promotion points.

So Joe's [DeviceAccount]s will change as follows:

Joe's Points

| Time | K-Brand | Z-Promo |
|---|---|---|
| T1 | +100 | |
| T3 | −20 | |
| T4 | −30 | |
| T5 | −20 | +30 |
| T6 | −20 | +9 |
| Balance | +10 | +39 |

The operation will also affect Z-Drink's [BusinessAccount]s like this:

Z-Drink's Promo Points

| Time | Point | Marcom | Morph | Redeem |
|---|---|---|---|---|
| T2 | −50 | +50 | | |
| T5 | | +30 | | |
| T6 | −9 | +9 | +9@+50% | |
| Balance | −59 | +89 | +9 | |

The [AwardTransaction] debits Z-Drink's [PointAccount]; and

since an [AwardTransaction] is also a [MarcomTransaction], it will also credit the [MarcomAccount]. Finally, the [MorphTransaction] proper will create an entry in the [MorphAccount]. Notice, in the above table, how the new entry in the [MorphAccount] highlights both the amount as well as the applicable trade commission (in this case, Z-Drink's trade commission of 50%).

T7—Joe Redeems 20 Z-Promo Points.

At time T7 Joe redeems 20 of his Z-Drink promotional points. His [DeviceAccount] will be updated to the following:

Joe's Points

| Time | K-Brand | Z-Promo |
|---|---|---|
| T1 | +100 | |
| T3 | −20 | |
| T4 | −30 | |
| T5 | −20 | +30 |
| T6 | −20 | +9 |
| T7 | | −20 |
| Balance | +10 | +19 |

Z-Drink's [BusinessAccount]s will look like this:

Z-Drink's Promo Points

| Time | Point | Marcom | Morph | Redeem |
|---|---|---|---|---|
| T2 | −50 | +50 | | |
| T5 | | +30 | | |
| T6 | −9 | +9 | +9@+50% | |
| T7 | +20 | | | +20 |
| Balance | −39 | +89 | +9 | +20 |

The 20 points that are added to the Z-Drink's [RedeemAccount] need to be debited for via one or more [RedeemCommission] s. Now, since there has been morph activity over this kind of points, there are retroactive trade commissions that must be accounted for when calculating the redemption debit. In this case there is only one [NorphEntry], for 9 points at 50% trade commission. Therefore a first [RedeemCommission] will be created. It's redemption value will be calculated as the (absolute value of the) amount of points of the first (and in this case only) morph entry (+9) multiplied by the point value (+1$) multiplied by the value multiplier (2). This results in a redemption value of +18$. The corresponding redemption debit is calculated as follows. First the promotional point's nominal redemption commission (10%) is increased by the trade commission (+50%), resulting in an effective redemption commission of 15%. The redemption debit is then calculated as the effective redemption commission (15%) of the redemption value (+18$). In other words the redemption debit of this first [RedeemCommission] will be+2.70$.

Now all the above takes into account only 9 of the original 20 points that had to be redeemed. There are no more [MorphEntry]s whose trade commissions need to be applied retroactively. Therefore, the remaining 20−9=11 points will give rise to a final [RedeemCommission]. This time the redemption value will be calculated as the amount of remaining points (11) multiplied by the point value (+1$) multiplied by the value multiplier (2). This results in a redemption value of +22$. The redemption debit is calculated as the redemption commission (10%) of the redemption value (+22$). In other words, the redemption debit of this second [RedeemCommission] will be+2.20$. In total the redemption will cost Z-Drink (2.70+2.20), i.e. 4.90$. This can be summarized with the following table:

Z-Drinks Redeem Commissions

| Time | Commission # | Redemption Debit |
|---|---|---|
| T7 | 1 | 2.70 |
| T7 | 2 | 2.20 |

In this case it is evident how Z-Drinks is paying for the retroactive trade commission that was debited due to the [MorphTransaction] to its favor at time T6. Notice how the payment takes place only when there is a tangible result: specifically the redemption (i.e. a sale) that takes place at time T7.

T8—Ann Redeems 30 K-Food Brand Points.

At time T8 Ann redeems 30 K-Food brand points. Her [DeviceAccount] will be updated to the following:

Ann's Points

| Time | K-Brand | Z-Promo |
|---|---|---|
| T2 | | +50 |
| T4 | +30 | |
| T5 | +20 | −30 |
| T8 | −30 | |
| Balance | +20 | +20 |

K-Food's [BusinessAccount]s will look like this:

K-Food's Brand Points

| Time | Point | Marcom | Morph | Redeem |
|---|---|---|---|---|
| T1 | −100 | +100 | | |
| T3 | +20 | | | +20 |
| T4 | | +30 | | |
| T5 | | +20 | | |
| T6 | +20 | | −20@−10% | |
| T8 | +30 | | | +30 |
| Balance | −30 | +150 | −20 | +50 |

The 30 points that are added to the K-Food's [RedeemAccount] need to be debited for via one or more [RedeemCommission]s. Now, since there has been morph activity over this kind of points, there are retroactive trade commissions that must be accounted for when calculating the redemption debit. In this case there is only one [MorphEntry], for −20 points at 10% trade commission. Therefore a first [RedeemCommission] will be created. Its redemption value will be calculated as the (absolute value of the) amount of points of the first (and in this case only) morph entry (+20) multiplied by the point value (+1$) multiplied by the value multiplier (1). This results in a redemption value of +20$. The corresponding redemption debit is calculated as follows. First the promotional point's nominal redemption commission (4%) is decreased by the trade commission (−10%), resulting in an effective redemption commission of 3.6%. The redemption debit is then calculated as the effective redemption commission (3.6%) of the redemption value (+20$). In other words the redemption debit of this first [RedeemCommission] will be+0.72$.

Now all the above takes into account only 20 of the original 30 points that had to be redeemed. There are no more [MorphEntry]s whose trade commissions need to be applied retroactively. Therefore, the remaining 30−20=10 points will give rise to a final [RedeemCommission]. This time the redemption value will be calculated as the amount of remaining points (10) multiplied by the point value (+1$) multiplied by the value multiplier (1). This results in a redemption value of +10$. The redemption debit is calculated as the redemption commission (4%) of the redemption value (+10$). In other words, the redemption debit of this second [RedeemCommission] will be+0.40$. In total the redemption will cost Z-Drink (0.72+0.40), i.e. 1.12$. This can be summarized with the following table (which also show the previous redeem commission).

K-Food's Redeem Commissions

| Time | Commission # | Redemption Debit |
|---|---|---|
| T3 | 1 | 0.80 |
| T8 | 2 | 0.72 |
| T8 | 3 | 0.40 |

In this case it is evident how K-Foods is compensated for the retroactive trade commission that was credited due to the [MorphTransaction] at time T6, when K-Food had to relinquish its points. Notice how the compensation takes place only when there is a tangible result: specifically the redemption (i.e. a sale) that takes place at time T7; and the compensation becomes a discount on the redemption debit.

### EXAMPLE SUMMARY

At the end of T8, we can summarize the situation with the following six tables:

Joe's Points

| Time | K-Brand | Z-Promo |
|---|---|---|
| T1 | +100 | |
| T3 | −20 | |
| T4 | −30 | |
| T5 | −20 | +30 |
| T6 | −20 | +9 |
| T7 | | −20 |
| Balance | +10 | +19 |

Ann's Points

| Time | K-Brand | Z-Promo |
|---|---|---|
| T2 | | +50 |
| T4 | +30 | |
| T5 | +20 | −30 |
| T8 | −30 | |
| Balance | +20 | +20 |

K-Food's Brand Points

| Time | Point | Marcom | Morph | Redeem |
|---|---|---|---|---|
| T1 | −100 | +100 | | |
| T3 | +20 | | | +20 |
| T4 | | +30 | | |
| T5 | | +20 | | |
| T6 | +20 | | −20@−10% | |
| T8 | +30 | | | +30 |
| Balance | −30 | +150 | −20 | +50 |

K-Food's Redeem Commissions

| Time | Commission # | Redemption Debit |
|---|---|---|
| T3 | 1 | 0.80 |
| T8 | 2 | 0.72 |
| T8 | 3 | 0.40 |

Z-Drink's Promo Points

| Time | Point | Marcom | Morph | Redeem |
|---|---|---|---|---|
| T2 | −50 | +50 | | |
| T5 | | +30 | | |
| T6 | −9 | +9 | +9@+50% | |
| T7 | +20 | | | +20 |
| Balance | −39 | +89 | +9 | +20 |

Z-Drinks Redeem Commissions

| Time | Commission # | Redemption Debit |
|---|---|---|
| T7 | 1 | 2.70 |
| T7 | 2 | 2.20 |

Some important considerations follow. While Ann was never awarded any K-Brand points directly, she nonetheless could take advantage of K-Food's offerings: because of the transfer (T2) and exchange (T5) transactions she gained ownership of K-Brand points.

When Joe morphed his 20 K-Brand points into 9 Z-Promo points (T6), Z-Drink got the benefit of having its points in the hands of a consumer, but without having sustained any effort. This benefit was then paid for retroactively, when there was a redemption (T7). The payment took form of an increase in the redemption debit.

Conversely, at the same morph occasion (T6), K-Food saw some of its brand points disappear from the hands of a consumer; K-Food got compensated for this retroactively when there was a redemption (T8). The compensation took form of an decrease in the redemption debit.

What is most striking in the above tables is the activity on the [MarcomAccount]s. While K-Food awarded points directly only once (T1), it had three occasions where by it could present a marketing communication message: T1, T4 and T5. (Similar considerations can be drawn for Z-Drink: while it awarded Z-promo points only once, at T2, marcom activities could take place at T2, T5 and T6.) Moreover, this occasions bear an important piece of information: the amount of points involved. This can be considered a direct measure of the level of interest by the consumer. So while K-Food actually issued and awarded 100 brand points, the resulting marketing communication activities pertained to 150 points. Finally, at each occasion it was known which device was the target of the marketing communication, and in turn could lead to examining recency, frequency and value of the corresponding accounts in order to personalize and tailor the marketing communication message itself.

Finally, it should be noted that the present invention is not limited to the embodiment described above, but can be varied within the scope of the appended claims.

1. A distributed computer system for the establishment of a marketplace for branded promotional values issued by at least two businesses and being awarded to at least two consumers, said distributed computer system comprising:
a persistent storage node arranged for storing data related to said promotional values, said at least two businesses and said at least two consumers;
an application server node for managing data stored by said persistent storage node, for executing transaction processing regarding said data, and for interfacing with said at least two businesses and said at least two consumers;
said distributed computer system being adapted for communicating with said at least two businesses and for communicating with mobile communication devices associated with said at least two consumers;
said distributed computer system being arranged to allow transactions involving said promotional values between said at least two businesses and said at least two consumers, thereby providing said marketplace between said at least two businesses, and between said at least two consumers, respectively.

2. A distributed computer system as claimed in claim 1, wherein said persistent storage node is constituted by a database server which comprises the following databases:
a mobile device database storing identification information and data related to mobile communication devices associated with said at least two consumers;
a business database storing data related to said at least two businesses; and
a transaction database storing data related to said transactions involving said promotional values.

3. A distributed computer system as claimed in claim 2, wherein said database server further comprises a promotions database storing data related to promotions performed by said businesses.

4. A distributed computer system as claimed in claim 1, wherein said application server node provides a set of core services according to which coordination and processing of said transactions, and interfacing with said persistent storage node are carried out.

5. A distributed computer system as claimed in any one of the preceding claims and being arranged in order to manage said promotional values in terms of non-zero amounts of branded M-points, where an M-point is invariably associated with the issueing business, and attributed by a point value freely determined by the corresponding issuing business.

6. A distributed computer system as claimed in claim 5, and being arranged for core services involving at least one of the following transactions:
an ownership transaction in which an amount of M-Points is transferred (1) from the corresponding issuing business to one individual consumer's mobile communication device; or (2) from one individual consumer's mobile communication device to a second and distinct individual consumer's mobile communication device; or (3) from an individual consumer's mobile communication device back to the original issuing business,
a redemption transaction in which a consumer redeems an amount of M-points, and
a trade transaction in which two ownership transactions are carried out concurrently.

7. A distributed computer system as claimed in claim 6, wherein said ownership transaction is constituted by either
a marcom transaction, during which a marketing communication message is transmitted to said mobile communication device, or
a withdraw transaction, during which an amount of M-points is returned to the corresponding said issuing business.

8. A distributed computer system as claimed in claim 7, wherein said marcom transaction is constituted by either
a transfer transaction during which one or more M-points are transferred from an account of a first consumer to an account of a further consumer, or
an award transaction during which one or more M-points are awarded by a business to a mobile communication device being associated with a consumer.

9. A distributed computer system as claimed in claim 6, wherein said trade transaction is constituted by either
a morph transaction during which a consumer is allowed to convert a non-zero amount of M-points relating to one business into a non-zero amount of M-points relating to a second and distinct business, and whereby the conversion ratio between the two amounts is determined automatically by said application server node depending on data from said businesses, or
an exchange transaction during which a first consumer transfers a non-zero amount of M-points relating to a first business to a second and distinct consumer, said second consumer returning to said first consumer a non-zero amount of M-points relating to a second and distinct business, whereby both amounts are freely determined by respective relinquishing consumer.

10. A distributed computer system as claimed in claim 5, and being arranged in order to handle promotions undertaken by businesses, and whereby each business can freely determine the start and stop time of its said promotions.

11. A distributed computer system as claimed in claim 5, and being arranged for managing different types of said M-points for each involved said businesses, in the form of a single brand point which is directly associated with the issuing business, and attributed by a value multiplier freely determined by the corresponding issuing business.

12. A distributed computer system as claimed in claim 5, further being arranged for managing said M-points in the form of a one or more of promotional points each of which, in addition to being associated with the issuing business, is also associated to a specific promotion undertaken by the issuing business, and attributed by a distinct value multiplier freely determined by the corresponding issuing business.

13. A distributed computer system as claimed in claim 5, and being arranged for managing each of said M-points in a manner which relates only to each individual mobile communication device, and not to a physical person owning said mobile communication device.

14. A distributed computer system as claimed in claim 5, wherein said system is arranged to manage said amounts of M-points with at least one account related to each mobile communication device and to each kind of point, and at least one account related to each business and each kind of point.

15. A distributed computer system as claimed in any of the preceding claims, comprising a web server adapted for communicating with said mobile communication devices, which in turn are constituted by Internet-enabled mobile devices such as cellular mobile telephones, personal digital assistants, personal computers, telematics equipped automobiles and other so-called “smart vehicles,” or yet other funciontally equivalent devices.

16. A method for the establishment of a marketplace of branded promotional values issued by at least two businesses and being awarded to at least two consumers, said method comprising:
storing data related to said promotional values, said at least two businesses and said at least two consumers in a persistent storage node;
managing said stored data and interfacing with said at least two businesses and said at least two consumers, by means of an application server node;
transmitting information related to said promotional values, said at least two businesses and said at least two consumers by communicating with said at least two businesses and with mobile communication devices being associated with said at least two consumers; and
allowing transactions involving said promotional values between said at least two businesses and said at least two consumers by means of said distributed computer system, thereby providing said marketplace between said at least two businesses, and between said at least two consumers, respectively.

17. A method as claimed in claim 16, wherein said step of storing data comprises at least one of the following:
storing data related to said mobile communication devices;
storing data related to promotions performed by said businesses; and
storing data related to transactions involving said promotional values.

18. A method as claimed in claim 16, wherein said promotional values are managed in the form of a non-zero amount of M-points, each of which corresponding to a predetermined point value determined by the corresponding issuing business.

19. A method as claimed in claim 18, wherein said method comprises carrying out at least one of the following transactions:
allowing a transfer of ownership in which a non-zero amount of M-Points is transferred (1) from the corresponding issuing business to one individual consumer's mobile communication device; or (2) from one individual consumer's mobile communication device to a second and distinct individual consumer's mobile communication device; or (3) from an individual consumer's mobile communication device back to the original issuing business, or
allowing redeeming of one or more M-points which are associated with a consumer's mobile communication device.

20. A method as claimed in claim 19, wherein said method comprises a morph transaction during which a consumer is allowed to convert a non-zero amount of M-points relating to one business into a non-zero amount of M-points relating to a second and distinct business, and whereby the conversion ratio between the two amounts is determined automatically by said application server node depending on data from said businesses.

21. A method as claimed in claim 19, wherein said transactions comprise:
transmitting a marketing communication message to a mobile communication device being associated with a transaction, or
returning said one or more M-points to said business.

22. A method as claimed in claim 19, wherein said transactions comprise:
converting a non-zero amount of M-points, which are associated with a consumer's mobile communication device and relating to a first business, into a non-zero amount (not necessarily equal to the first amount) of M-points relating to a second and distinct business, or
exchanging a non-zero amounts of M-points in a manner so that a first consumer transfers a non-zero amount of M-points relating to a first business to a second and distinct consumer, said second consumer returning to said first consumer a non-zero amount (not necessarily equal to the first amount) of M-points relating to a second and distinct business, whereby both amounts are freely determined by respective relinquishing consumer.

23. A method as claimed in claim 19, wherein said transfer of ownership of M-points comprises:
transferring one or more M-points from a first consumer's mobile communication device to a second and distinct consumer's mobile communication device, or
awarding one or more M-points by a business to a consumer's mobile communication device.

24. A method as claimed in claim 17, and comprising managing different types of M-points for each involved said businesses in the form of a single brand point which is directly associated with the issuing business, and attributed by a value multiplier freely determined by the corresponding issuing business.

25. A method as claimed in claim 17, and comprising managing said M-points in the form of a one or more of promotional points each of which, in addition to being associated with the brand of the issuing business, is also associated to a specific promotion undertaken by the issuing business, and attributed by a value multiplier freely determined by the corresponding issuing business.

26. A method as claimed in claim 17, and comprising managing each M-point in a manner which relates only to each individual mobile communication device, and whereby no private information regarding a physical person is stored.

27. A method as claimed in claim 16, comprising managing said amounts of M-points with at least one account related to each mobile communication device, and at least one account related to each business.

28. A method as claimed in any one of claims 16-27, comprising communicating via the Internet with said mobile communication devices, which are constituted by Internet-enabled mobile devices such as cellular mobile telephones, personal digital assistants, personal computers, telematics equipped automobiles and other so-called “smart vehicles,” or yet other funciontally equivalent devices.

29. A method for facilitating and improving marketing and promotional activities through the establishment of a marketplace of branded promotional values issued by at least two businesses and being awarded to at least two consumers, said method comprising:
storing data related to said promotional values, said at least two businesses and said at least two consumers;
managing stored data and transmitting data related to said promotional values to and from mobile communication devices being associated with said consumers; and
allowing transactions involving said promotional values between said at least two businesses and said at least two consumers, thereby providing said marketplace between said at least two businesses, and between said at least two consumers, respectively.

30. A method as claimed in claim 29, wherein said promotional values are managed in terms of non-zero amounts of branded M-points, where an M-point is invariably associated with the issueing business, and attributed by a point value freely determined by the corresponding issuing business.

31. A method as claimed in claim 30, wherein a particular M-point is constituted by a brand point which is directly associated with the issuing business.

32. A method as claimed in claim 30, wherein a particular M-point is constituted by one or more of promotional points each of which, in addition to being associated with the issuing business, is also associated to a specific promotion undertaken by the issuing business.

33. A method as claimed in claim 30, wherein said M-points are awarded to a mobile communication device associated with a consumer either by said business or by another consumer.

34. A method as claimed in claim 33, wherein the awarding of said M-points to said mobile communication device comprises transmission of a marketing communication message for presentation to said consumer via said mobile communication device.

35. A method as claimed in claim 34, wherein said transmission of a marketing communication message is invariably actuated as a result of said consumer participating in at least one predetermined point-earning opportunity and any thereof ensuing M-point transaction.

36. A method as claimed in claim 30, wherein each consumer's interest level in promotional offerings from each one of said at least two businesses can be inferred and determined indirectly by their M-point transaction activity.

37. A method as claimed in claim 36, wherein different marketing communication messages are transmitted to different mobile communication devices depending consumer's said inferred interest level.

38. A method as claimed in claim 32, and being arranged in order to handle promotions undertaken by businesses, and whereby each business can freely determine the start and stop time of its said promotions.

39. A method as claimed in claim 38, wherein said promotion is associated with a start point of time and a stop point of time, which together define the time period during which the promotional points associated with said promotion can be subject to any kind of M-point transactions.

40. A method as claimed in claim 39, wherein said promotional point can be redeemed between said start point of time and said stop point of time, but cannot be redeemed after the expiration of said stop point of time; however after the expiration of the promotional period said promotional point can yet be subject to any kind of M-point transaction except a redemption transaction

41. A method as claimed in claim 40, wherein expired promotional M-points can be reinstantiated by the issuing business by re-allowing redemption transactions thereof.

42. A method as claimed in claim 30, wherein said M-point is given a value, determined by a point value attribute and a value multiplier attribute, both of which are freely determined by the issuing business.

43. A method as claimed in claim 30, wherein the handling of said M-points comprises at least one of the following transactions:
an ownership transaction in which an amount of M-Points is transferred (1) from the corresponding issuing business to one individual consumer's mobile communication device; or (2) from one individual consumer's mobile communication device to a second and distinct individual consumer's mobile communication device; or (3) from an individual consumer's mobile communication device back to the original issuing business.,
a redemption transaction in which a consumer redeems an amount of M-points, and
a trade transaction in which two ownership transactions are carried out concurrently.

44. A method as claimed in claim 43, wherein said trade transaction is either
a morph transaction during which a consumer is allowed to convert a non-zero amount of M-points relating to one business into a non-zero amount of M-points relating to a second and distinct business, and whereby the conversion ratio between the two amounts is determined automatically depending on data from said businesses, or
an exchange transaction during which a first consumer transfers a non-zero amount of M-points relating to a first business to a second and distinct consumer, said second consumer returning to said first consumer a non-zero amount of M-points relating to a second and distinct business, whereby both amounts are freely determined by respective relinquishing consumer.

45. A method as claimed in claim 44, wherein said morph transaction allows co-/cross-marketing between different businesses, said transaction being mediated by a service provider without any direct relationship between said businesses.

46. A method as claimed in claim 45, wherein all compensations and charges between said businesses are handled retroactively as a percent reduction or increase on the ordinary redemption commission due to the service provider.

47. A method as claimed in any one of claims 30-46, wherein said M-points can be allowed to be redeemed by said consumer in exchange for said promotional values.
